(19) United States
(12) Patent Application Publication
(10) Pub. No.: US 2018/0375780 A1
(43) Pub. Date: Dec. 27, 2018

(54) RECEIVER, TRANSMITTER, AND METHOD FOR ESTIMATING AVAILABLE BANDWIDTH

(71) Applicant: NEC Corporation, Minato-ku, Tokyo (JP)

(72) Inventor: Anan SAWABE, Tokyo (JP)

(73) Assignee: NEC Corporation, Minato-ku, Tokyo (JP)

(21) Appl. No.: 16/062,199

(22) PCT Filed: Dec. 16, 2016
(86) PCT No.: PCT/JP2016/087550

§ 371 Date: Jun. 14, 2018

(30) Foreign Application Priority Data
Dec. 25, 2015 (JP) 2015-252961

(51) Int. Cl. H04L 12/841; H04L 12/801; H04L 1/18

(52) U.S. Cl. CPC H04L 47/283; H04L 1/1812; H04L 47/34

(57) ABSTRACT

The present invention addresses the problem of providing a receiver or the like capable of reducing variation that occurs when estimating available bandwidth for a network in which delay times fluctuate significantly. To solve the problem, a target packet group comprising target packets used to calculate estimates of available bandwidth, is specified from among a delayed packet group comprising delayed packets among those received, delayed when passing through a network. The target packet group is specified using a delay time based on calculations and a delay time obtained through measurement. Furthermore, a target time is calculated as an estimate of the time required for the target packet group to pass through the network, and a target data volume is calculated as an estimate of the total volume of data received from each target packet constituting the target packet group.

### TECHNICAL FIELD

The present invention relates to a method for estimating an available bandwidth on a communication line.

### BACKGROUND ART

An available bandwidth (also referred to as a “usable bandwidth”) of a communication bandwidth refers to a free bandwidth obtained by subtracting a bandwidth of cross traffic being another type of traffic flowing in a network from a physical bandwidth of a bottleneck link of a communication line. For example, when a physical bandwidth of a bottleneck link of a communication line is 100 Mbps and a bandwidth of cross traffic is 30 Mbps, an available bandwidth is 100−30=70 Mbps.

Estimation of an available bandwidth is important for smoothly performing a video chat, a videophone call, a videoconference, and the like that perform communication and the like by bidirectionally transmitting images between terminals. The reason is that keeping a transmission rate of an image at or below an estimate of an available bandwidth enables prevention of a packet loss through preventing a total of the transmission rate of the image and cross traffic from exceeding a physical bandwidth of a bottleneck link of a communication line, and therefore an image quality can be secured.

For example, methods of estimating an available bandwidth are disclosed in PTLs 1 and 2.

An estimation packet reception means in an information processing system disclosed in PTL 1 receives the estimation packet transmitted from the estimation packet transmission means. Further, a packet information acquisition means acquires a reception time and a packet size of the estimation packet received by the estimation packet reception means. A delay starting packet detection means detects, as a delay starting packet, an estimation packet from which reception intervals of estimation packets transmitted one after another start to change, out of a plurality of the estimation packets received by the estimation packet reception means. The detection of an estimation packet as a delay starting packet from which reception intervals start to change is performed, based on the reception times of the estimation packets received first and last. Then, a bandwidth calculation means calculates a bandwidth of the network by use of a packet size of the delay starting packet detected by the delay starting packet detection means.

Further, PTL 2 discloses an available bandwidth measurement device for measuring an available bandwidth being a maximum traffic value that may flow through a network path connecting between any hosts in a packet switching network. A measurement means in the available bandwidth measurement device receives an ACK packet from the reception side in response to packet transmission by an application. The ACK packet refers to an acknowledgement response packet. Then, every time the ACK packet is received, the available bandwidth measurement device totals received data volumes reaching the reception side, the data volume being stored in the ACK packet, and repeats measurement until the total number of the received ACK packets reaches a predetermined number of packets. Further, when the total number of the ACK packets reaches the predetermined number of packets, the available bandwidth calculation means determines whether a measurement period up to reaching the predetermined number of packets is greater than or equal to a predetermined time. Then, when the measurement period is less than the predetermined time, the available bandwidth calculation means increases the predetermined number of packets and repeats the measurement means. Then, when the measurement period is greater than or equal to the predetermined time, the available bandwidth calculation means calculates an available bandwidth by dividing a cumulative received data volume totaled by the measurement means by the measurement period.

In relation to the present invention, PTL 3 discloses a method of estimating an available bandwidth other than the methods described above and also discloses descriptions of a packet train and a queuing delay.

### CITATION LIST

### Patent Literature

[PTL 1] Japanese Laid-open Patent Publication No. 2014-116771

[PTL 2] Japanese Laid-open Patent Publication No. 2013-232851

[PTL 3] International Application Publication No. WO 2014/017140

### SUMMARY OF INVENTION

### Technical Problem

However, the information processing system disclosed in PTL 1 detects, as a delay starting packet, an estimation packet from which reception intervals start to change. Then, the bandwidth calculation means in the information processing system disclosed in PTL 1 calculates a bandwidth of the network by use of a packet size of the delay starting packet detected by the delay starting packet detection means. Accordingly, even when a change in a reception interval of an estimation packet from which reception intervals start to change is due to another cause such as HARQ, the estimation packet is detected as a delay starting packet. Hear HARQ represents a Hybrid Automatic Repeat reQuest being a retransmission mechanism used in a mobile phone network. Then, a bandwidth of the network is calculated by use of a packet size of the detected delay starting packet. Accordingly, the information processing system disclosed in PTL 1 is highly likely to cause an error in an available bandwidth estimate by a delay due to another cause.

Further, the available bandwidth measurement device disclosed in PTL 2 waits until a measurement period up to the total number of the received ACK packets reaching the predetermined number of packets becomes a predetermined time or greater. Then, when the measurement period becomes the predetermined time or greater, an available bandwidth is calculated by dividing a cumulative received data volume totaled by the measurement means by the measurement period. Accordingly, when the cumulative received data volume is influenced by a delay due to another cause such as HARQ, the calculation is influenced by the other delay. When influenced by the other delay, the available bandwidth estimate is highly likely to have an error.

Accordingly, the methods disclosed in PTLs 1 and 2 have a problem that an estimate of an available bandwidth varies in a network with significant delay time fluctuations due to influence of a delay caused by HARQ or the like.

An object of the present invention is to provide a method of estimating an available bandwidth and the like capable of reducing variation in estimates of an available bandwidth, the variation occurring in a network with significant delay time fluctuations.

### Solution to Problem

A receiver according to the present invention includes a reception means, a target specification means, a target time calculation means, a target data volume calculation means, and an estimate calculation means.

The reception means receives one or more packets transmitted to the reception means through a network.

The target specification means specifies, from a delayed packet group composed of one or more delayed packets being the packets being delayed when passing through the network, a target packet group composed of one or more target packets being the packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets.

The target time calculation means calculates a target time being an estimate of a time required for the target packet group to pass through the network.

The target data volume calculation means calculates a target data volume being a total estimate of received data volumes of respective target packets constituting the target packet group.

The estimate calculation means obtains the available bandwidth estimate by dividing the target data volume by the target time.

### Advantageous Effects of Invention

A receiver and the like according to the present invention are able to reduce variation in estimates of an available bandwidth, the variation occurring in a network with significant delay time fluctuations.

### BRIEF DESCRIPTION OF DRAWINGS

FIG. 1 is a conceptual diagram illustrating a network configuration example to which a receiver according to a first example embodiment is applicable.

FIG. 2 is a conceptual diagram illustrating a data structure example of data stored by a storage means according to the first example embodiment.

FIG. 3 is a conceptual diagram illustrating an example of a processing flow of processing according to the first example embodiment performed by a transmitter.

FIG. 4 is a conceptual diagram illustrating an example of a processing flow of processing according to the first example embodiment performed by a reception means.

FIG. 5 is a conceptual diagram illustrating an example of a processing flow of processing of obtaining a delay time of a packet, according to the first example embodiment, performed by the reception means.

FIG. 6 is a conceptual diagram illustrating an example of a processing flow of processing according to the first example embodiment performed by a target specification means.

FIG. 7 is a conceptual diagram illustrating an example of a processing flow of processing according to the first example embodiment performed by a target time calculation means.

FIG. 8 is a conceptual diagram illustrating an example of a processing flow of processing according to the first example embodiment performed by a target data volume calculation means.

FIG. 9 is a conceptual diagram illustrating an example of a processing flow of processing according to the first example embodiment performed by an estimate calculation means.

FIG. 10 is a conceptual diagram illustrating an example of a processing flow of processing according to a second example embodiment performed by a target specification means.

FIG. 11 is a conceptual diagram (part 1) illustrating an example of a processing flow of processing in S143 and S144 indicated in FIG. 10, according to the second example embodiment, performed by the target specification means 220.

FIG. 12 is a conceptual diagram (part 2) illustrating an example of a processing flow of the processing in S143 and S144 indicated in FIG. 10, according to the second example embodiment, performed by the target specification means 220.

FIG. 13 is a conceptual diagram illustrating an example of a processing flow of processing according to a third example embodiment performed by an estimate calculation means.

FIG. 14 is a conceptual diagram (part 2-1) illustrating an example of a processing flow of processing according to a fourth example embodiment, performed by an estimate calculation means 250.

FIG. 15 is a conceptual diagram (part 2-2) illustrating an example of a processing flow of the processing according to the fourth example embodiment, performed by the estimate calculation means 250.

FIG. 16 is a conceptual diagram illustrating a first specific example of processing according to the fourth example embodiment performed by a receiver.

FIG. 17 is a conceptual diagram illustrating a second specific example of processing according to the fourth example embodiment performed by the receiver.

FIG. 18 is a diagram illustrating a relation between a delay and a transmission sequence number i.

FIG. 19 is a diagram illustrating a frequency of a delay starting to increase at a packet with a transmission sequence number i.

FIG. 20 is a diagram illustrating a frequency of a calculated available bandwidth estimate when the estimate is obtained without applying the present invention.

FIG. 21 is a diagram illustrating a frequency of a calculated available bandwidth estimate when the estimate is calculated by the receiver according to the fourth example embodiment.

FIG. 22 is a diagram illustrating a frequency of a calculated available bandwidth estimate.

FIG. 23 is a conceptual diagram illustrating an example of a processing flow of processing in S143 indicated in FIG. 10, according to a fifth example embodiment, performed by a target specification means.

FIG. 24 is a conceptual diagram illustrating a specific example of processing according to the fifth example embodiment performed by a receiver.

FIG. 25 is a conceptual diagram illustrating a minimum configuration of a receiver according to the present invention.

### EXAMPLE EMBODIMENT

### First Example Embodiment of Present Invention

A first example embodiment of the present invention (hereinafter referred to as a “first example embodiment”) is an example embodiment related to a receiver and the like obtaining an available bandwidth estimate by a packet group composed of a packet selected based on a calculated delay and a measured delay.

[Configuration and Operation]

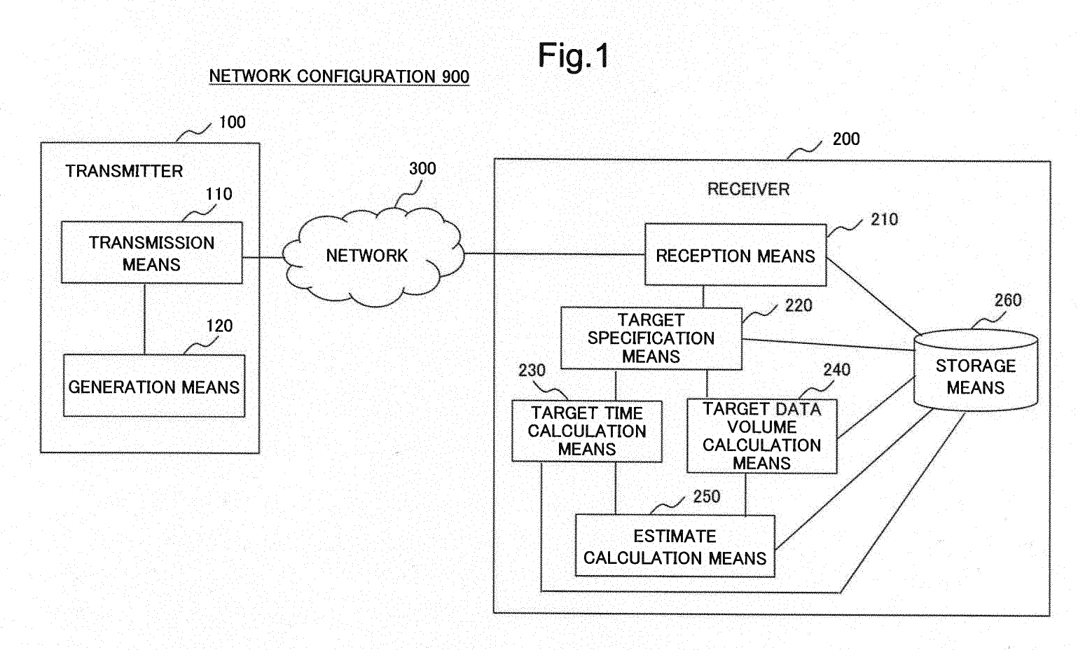

FIG. 1 is a conceptual diagram illustrating a network configuration 900 being a configuration example of a network to which a receiver 200 being an example of a receiver according to the first example embodiment is applied.

The network configuration 900 includes a transmitter 100, the receiver 200, and a network 300.

The transmitter 100 and the receiver 200 are connected through the network 300. In other words, the transmitter 100 and the receiver 200 are in a communicable state through the network 300.

For example, each of the transmitter 100 and the receiver 200 is a personal computer (PC), or a mobile computer (personal digital assistant [PDA]). Alternatively, for example, each of the transmitter 100 and the receiver 200 is a mobile phone, a smartphone, a tablet terminal, a fixed-line phone, or an on-the-street multimedia terminal. Alternatively, for example, each of the transmitter 100 and the receiver 200 is an onboard terminal, a network-connectable television, a network-connectable set-top box, or a game machine. Alternatively, for example, each of the transmitter 100 and the receiver 200 is a network-connectable printer, a network-connectable scanner, or another similar device with a function of exchanging information with the outside.

Unillustrated devices other than the transmitter 100 and the receiver 200 may be connected to the network 300. When unillustrated devices are connected, cross traffic flowing between the unillustrated devices other than the transmitter 100 and the receiver 200 may exist in the network 300.

The transmitter 100 includes a transmission means 110 and a generation means 120.

The receiver 200 includes a reception means 210, a target specification means 220, a target time calculation means 230, a target data volume calculation means 240, an estimate calculation means 250, and a storage means 260.

The generation means 120 in the transmitter 100 generates a packet train. As described in PTL 3, the packet train is a packet group for estimating an available bandwidth, the packet train being transmitted to the receiver 200 by the transmitter 100. Transmission intervals of respective packets constituting a packet train are regular intervals. Further, a packet size of each packet constituting a packet train gradually increases as a transmission sequence number i of the packet becomes greater (as the packet is transmitted later).

The generation means 120 transmits a generated packet train to the transmission means 110.

The transmission means 110 in the transmitter 100 transmits a packet train transmitted to the transmission means 110 by the generation means 120 to the reception means 210 in the receiver 200. The transmission means 110 transmits the packet train to the reception means 210 through the network 300.

The reception means 210 in the receiver 200 receives through the network 300 a packet train transmitted to the reception means 210 by the packet transmission means 110. The reception means 210 transmits the received packet train to the target specification means 220.

The target specification means 220 specifies a starting packet and an ending packet in a target packet group with respect to a packet train transmitted to the target specification means 220 by the reception means 210. The “target packet group” refers to a packet group used by the estimate calculation means 250 for calculation of an available bandwidth estimate to be described later, out of packet groups constituting a packet train. Further, the starting packet refers to a packet with a minimum value of a transmission sequence number i (transmitted earliest), the packet being transmitted by the transmission means 110, out of packets constituting a target packet group. Further, the ending packet refers to a packet with a maximum value of a transmission sequence number i (transmitted latest), the packet being transmitted by the transmission means 110, out of the packets constituting the target packet group.

The target specification means 220 specifies a packet being delayed while passing through the network 300 (hereinafter referred to as a “delayed packet”), out of packets constituting a packet train. Then, the target specification means 220 specifies a target packet group from a delayed packet group composed of delayed packets. The target specification means 220 specifies the target packet group, based on a calculated delay time obtained for each delayed packet and a delay time obtained for each delayed packet by measurement. The calculated delay time is a calculated delay time obtained for each of the delayed packets assuming a target delay being a delay assumed for calculation of an available bandwidth estimate.

Details of the method of the target specification means 220 specifying a target packet, based on a calculated delay time and a delay time obtained by measurement, will be described in and after a second example embodiment of the present invention.

The target specification means 220 causes the storage means 260 to store information indicating a target packet group specified by the target specification means 220. Further, the target specification means 220 causes the storage means 260 to store information indicating a target packet group specified by the target specification means 220.

The target time calculation means 230 calculates a target time being an estimate of a time required for a target packet group to pass through the network 300, from a starting packet and an ending packet that are read from the storage means 260. The target time is a time between a time when the reception means 210 receives the starting packet and a time when the reception means 210 receives the ending packet, and is a value used for calculation of an available bandwidth estimate, to be described later, by the estimate calculation means 250. The target time calculation means 230 causes the storage means 260 to store information indicating the target time calculated by the target time calculation means 230.

The target data volume calculation means 240 calculates a “target data volume” being an estimate of a sum of data volumes of all packets in a target packet group, based on a received data volume of each packet in the target packet group read from the storage means 260. The target data volume calculation means 240 causes the storage means 260 to store information indicating the target data volume.

The estimate calculation means 250 divides a target data volume read from the storage means 260 by a target time read from the storage means 260. Then, the estimate calculation means 250 sets the value obtained by dividing the target data volume by the target time as an available bandwidth estimate. The estimate calculation means 250 causes the storage means 260 to store the available bandwidth estimate.

In accordance with an instruction from each component in the receiver 200, the storage means 260 stores the instructed information. Further, in accordance with an instruction from each component in the receiver 200, the storage means 260 sends the instructed stored information.

The storage means 260 may be composed of a plurality of storage means. In that case, each of the plurality of storage means may be installed at different locations.

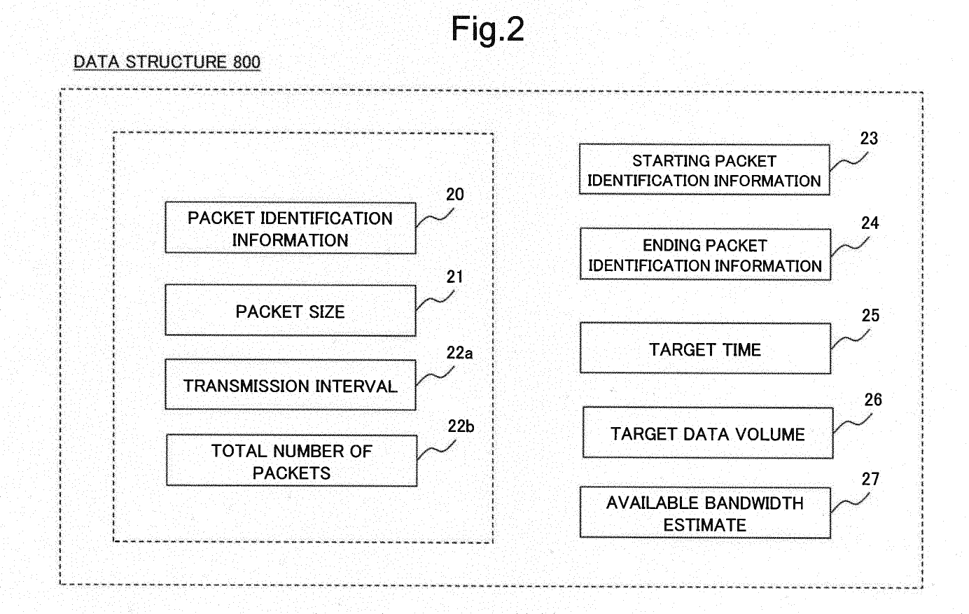

For example, the storage means 260 may store information with a data structure illustrated in FIG. 2.

FIG. 2 is a conceptual diagram illustrating a data structure 800 being a data structure example of data stored by the storage means 260 illustrated in FIG. 1.

The data structure 800 includes packet identification information 20, a packet size 21, a transmission interval 22a, a total number of packets 22b, and starting packet identification information 23. The data structure 800 further includes ending packet identification information 24, a target time 25, a target data volume 26, and an available bandwidth estimate 27.

The packet identification information 20 is information for identifying a packet being a target represented by the data structure 800.

The packet size 21 is a packet size of a packet identified by the packet identification information 20.

The total number of packets 22b is a total number of packets constituting a packet train.

The starting packet identification information 23 is information for identifying a starting packet.

The ending packet identification information 24 is information for identifying an ending packet.

The target time 25 is a target time described in the description of FIG. 1.

The target data volume 26 is a target data volume described in the description of FIG. 1.

The available bandwidth estimate 27 is an available bandwidth estimate calculated by the receiver 200.

[Processing Flow]

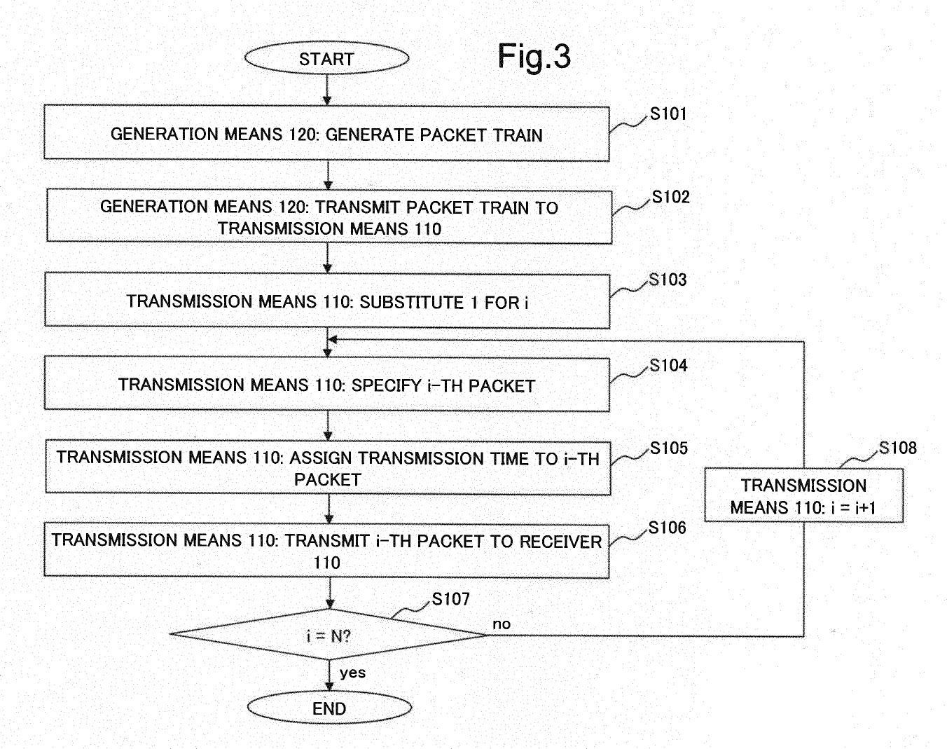

FIG. 3 is a conceptual diagram illustrating an example of a processing flow of processing performed by the transmitter 100 illustrated in FIG. 1. In each step of the processing indicated in FIG. 3, a part at the left of a colon mark (:) indicates a processing entity performing the processing, and a part at the right of the colon mark (:) indicates details of the processing performed by the processing entity.

First, as processing in S101, the generation means 120 generates a packet train. When generating a packet train, the generation means 120 assigns a transmission sequence number i to each packet constituting the packet train. Note that i denotes a positive integer less than or equal to N. N denotes a total number of packets included in the packet train. Further, the generation means 120 causes each packet constituting the packet train to include information by which the packet can be identified as a packet in the packet train.

Next, as processing in S102, the generation means 120 transmits information including the packet train generated by the generation means 120 to the transmission means 110.

Next, as processing in S103, the transmission means 110 substitutes 1 for the transmission sequence number i.

Then, as processing in S104, the transmission means 110 specifies a packet with a transmission sequence number i from a packet group constituting the packet train.

Next, as processing in S105, the transmission means 110 assigns a transmission time to the packet with the transmission sequence number i specified in the processing in S104 and attaches the time to the packet.

Then, as processing in S106, the transmission means 110 promptly transmits the packet with the transmission sequence number i to the receiver 200 illustrated in FIG. 1.

Next, as processing in S107, the transmission means 110 determines whether the transmission sequence number i is equal to the total number of packets N.

When determining through the processing in S107 that the transmission sequence number i is equal to the total number of packets N, the transmission means 110 ends the processing indicated in FIG. 3.

On the other hand, when not determining through the processing in S107 that the transmission sequence number i is equal to the total number of packets N, the transmission means 110 performs processing in S108.

When performing the processing in S108, the transmission means 110 substitutes i+1 for the transmission sequence number i, as the processing in S108.

Then, the transmission means 110 performs the aforementioned processing in S104.

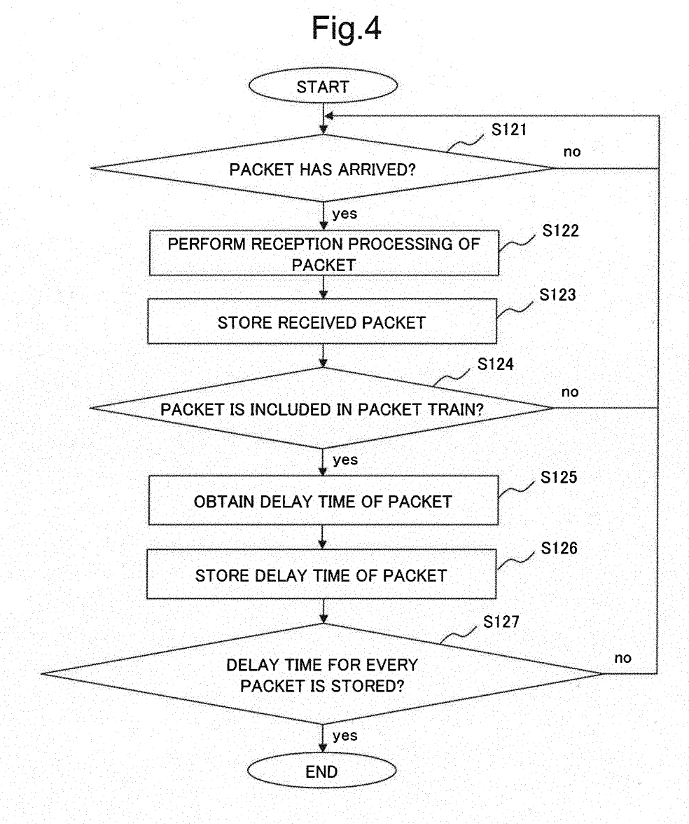

FIG. 4 is a conceptual diagram illustrating an example of a processing flow of processing performed by the reception means 210 in the receiver 200 illustrated in FIG. 1.

First, as processing in S121, the reception means 210 determines whether a packet has arrived at the reception means 210 through the network 300 illustrated in FIG. 1.

When determining through the processing in S121 that a packet has arrived at the reception means 210, the reception means 210 performs processing in S122.

On the other hand, when not determining through the processing in S121 that a packet has arrived at the reception means 210, the reception means 210 performs the aforementioned processing in S121 again.

When performing the processing in S122, the reception means 210 performs reception processing of a packet, as the processing in S122. In the reception processing of the packet, the reception means 210 identifies a reception time of the packet. Then, the reception means 210 attaches the reception time of the packet on which the reception processing is performed to the packet. The reception means 210 performs the reception processing of the packet promptly after the arrival of the packet at the reception means 210.

Next, as processing in S123, the reception means 210 causes the storage means 260 to store the packet on which the reception processing is performed in S122.

Then, as processing in S124, the reception means 210 determines whether the packet on which the reception processing is performed is a packet constituting a packet train. The determination of whether the packet is a packet constituting the packet train is performed by reading information included in the packet.

When determining through the processing in S124 that the packet on which the reception processing is performed is a packet constituting the packet train, the reception means 210 performs processing in S125.

On the other hand, when not determining through the processing in S124 that the packet on which the reception processing is performed is a packet constituting the packet train, the reception means 210 performs the aforementioned processing in S121 again.

When performing the processing in S125, the reception means 210 obtains a delay time Q(i) of the packet determined to be a packet in the packet train through the processing in S124, as the processing in S125. Note that i denotes the aforementioned positive integer indicating a transmission sequence number of a packet in a packet train. In other words, the delay time Q(i) denotes a delay time of a packet with a transmission sequence number being i. The processing of the reception means 210 obtaining the delay time Q(i) will be described later in the first example embodiment.

Next, as processing in S126, the reception means 210 causes the storage means 260 to store the delay time Q(i) obtained by the reception means 210.

Then, as processing in S127, the reception means 210 determines whether a delay time for every packet constituting the packet train being a target is stored in the storage means 260.

When determining through the processing in S127 that a delay time for every packet is stored in the storage means 260, the reception means 210 ends the processing indicated in FIG. 4.

On the other hand, when not determining through the processing in S127 that a delay time for every packet is stored in the storage means 260, the reception means 210 performs the aforementioned processing in S121 again.

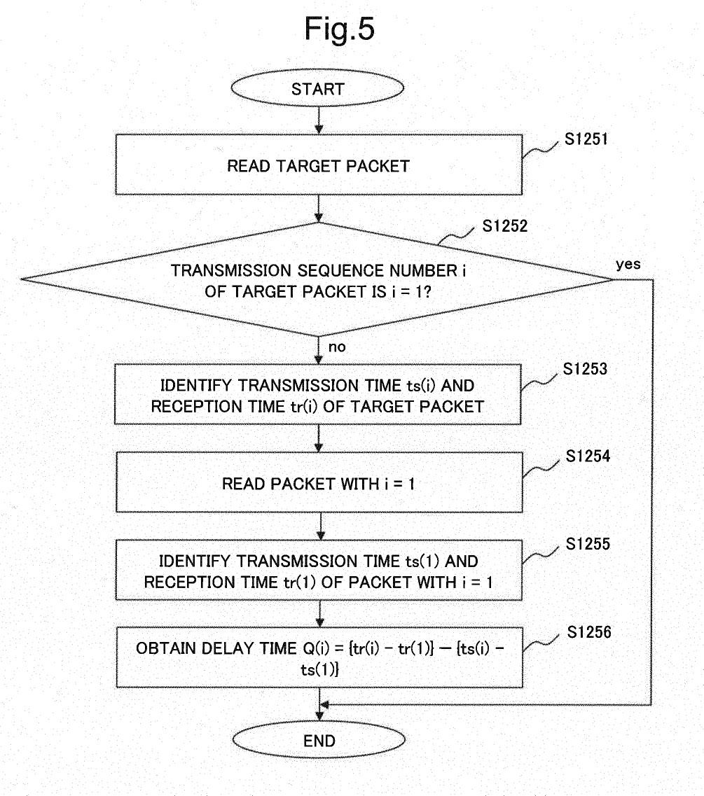

FIG. 5 is a conceptual diagram illustrating an example of a processing flow of the processing of obtaining a delay time of a packet constituting a packet train by the reception means 210, as the processing in S125 indicated in FIG. 4.

First, in processing in S1251, the reception means 210 reads from the storage means 260 a packet being a processing target in FIG. 5, the packet being stored in the storage means 260 through the processing in S123 in FIG. 4.

Then, in processing in S1252, the reception means 210 determines whether the packet read through the processing in S1251 is a packet with a transmission sequence number i being i=1.

When determining through the processing in S1252 that the read packet is a packet with a transmission sequence number i being i=1, the reception means 210 ends the processing indicated in FIG. 5.

On the other hand, when not determining through the processing in S1252 that the read packet is a packet with a transmission sequence number i being i=1, the reception means 210 performs processing in S1253.

When performing the processing in S1253, the reception means 210 identifies a transmission time ts(i) and a reception time tr(i) of the read packet from information included in the packet, as the processing in S1253.

Next, as processing in S1254, the reception means 210 reads from the storage means 260 a packet with a transmission sequence number i=1.

Then, as processing in S1255, the reception means 210 identifies a transmission time ts(1) and a reception time tr(1) of the packet with the transmission sequence number i=1.

Next, as S125, the reception means 210 obtains a delay time Q(i) of the packet with the transmission sequence number i. The delay time Q(i) obtained by the reception means 210 is given by the delay time Q(i)={tr(i)−tr(1)}−{ts(i)−ts(1)}. The transmission time ts(i) and the reception time tr(i) of the read packet are times identified by the reception means 210 through the processing in S1253. Further, the transmission time ts(1) and the reception time tr(1) of the packet with the transmission sequence number i=1 are times identified by the reception means 210 through the processing in S1255.

Then, the reception means 210 ends the processing in FIG. 5.

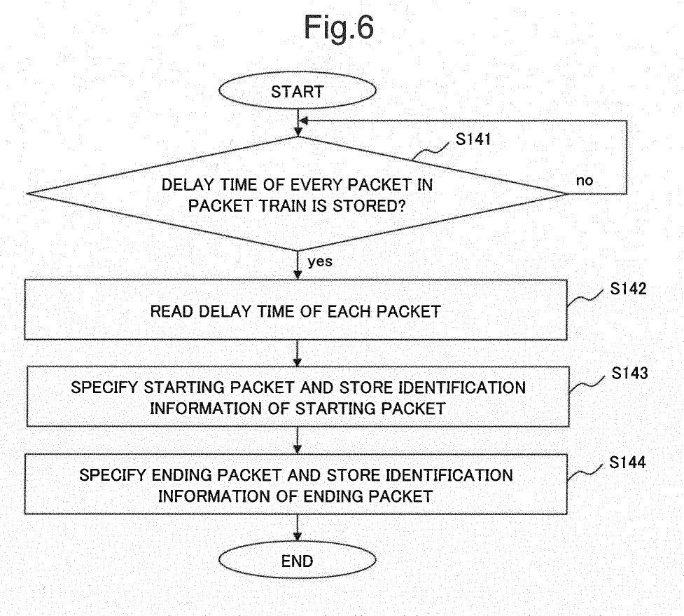

FIG. 6 is a conceptual diagram illustrating an example of a processing flow of processing performed by the target specification means 220 illustrated in FIG. 1.

First, the target specification means 220 determines whether the storage means 260 stores a delay time for every packet constituting a packet train being a target of the processing indicated in FIG. 5.

When determining that a delay time for every packet is stored, the target specification means 220 performs processing in S142.

On the other hand, when not determining that a delay time for every packet is stored, the target specification means 220 performs the aforementioned processing in S141 again.

When performing the processing in S142, the target specification means 220 reads from the storage means 260 a delay time of each packet for all N packets, as the processing in S142.

Then, as processing in S143, the target specification means 220 specifies a starting packet. The target specification means 220 selects the starting packet from packets being delayed, based on a delay time obtained by calculation and a delay time obtained by measurement. A specific selection method of the starting packet will be described in and after the second example embodiment of the present invention. Then, the target specification means 220 causes the storage means 260 to store identification information of the specified starting packet.

Next, as processing in S144, the target specification means 220 specifies an ending packet. The target specification means 220 selects an ending packet from packets having a value of a transmission sequence number i greater (transmitted later) than the transmission sequence number i of the starting packet and also being delayed. The target specification means 220 selects the ending packet from packets being delayed, based on a delay time obtained by calculation and a delay time obtained by measurement. A specific selection method of the ending packet will be described in and after the second example embodiment of the present invention. Then, the target specification means 220 causes the storage means 260 to store identification information of the specified ending packet.

Then, the target specification means 220 ends the processing indicated in FIG. 6.

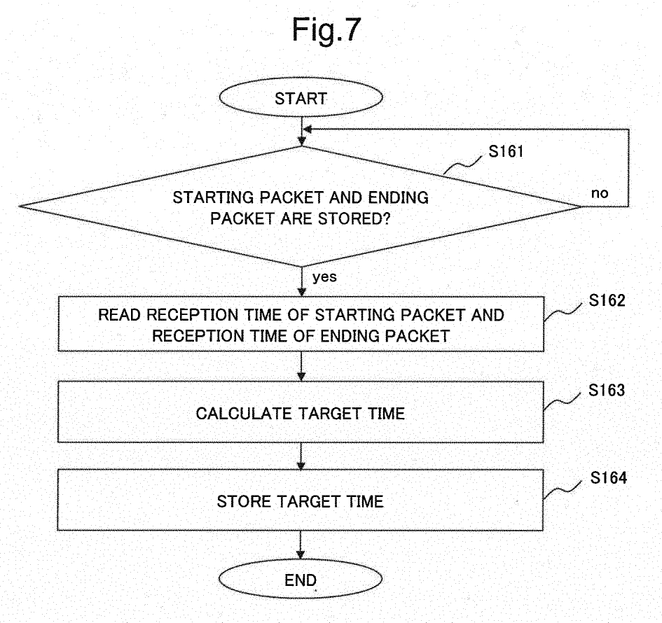

FIG. 7 is a conceptual diagram illustrating an example of a processing flow of processing performed by the target time calculation means 230.

First, as processing in S161, the target time calculation means 230 determines whether the storage means 260 stores identification information of a starting packet and an ending packet. In order for the target time calculation means 230 to make the determination, for example, the storage means 260 is set to transmit a notification signal to the target time calculation means 230 when the storage means 260 stores identification information of both a starting packet and an ending packet. Then, the target time calculation means 230 makes the determination depending on whether or not the notification signal is received.

When determining through the processing in S161 that the storage means 260 stores the identification information of the starting packet and the ending packet, the target time calculation means 230 performs processing in S162.

On the other hand, when not determining through the processing in S161 that the storage means 260 stores the identification information of the starting packet and the ending packet, the target time calculation means 230 performs the aforementioned processing in S161 again.

When performing the processing in S162, the target time calculation means 230 reads from the storage means 260 a reception time of the starting packet and a reception time of the ending packet, as the processing in S162.

Then, as processing in S163, the target time calculation means 230 calculates a target time, based on the reception time of the starting packet and the reception time of the ending packet that are read through the processing in S162. The target time refers to a time period from the reception time of the starting packet to the reception time of the ending packet.

Then, as processing in S164, the target time calculation means 230 causes the storage means 260 to store the target time obtained through the processing in S143.

Then, the target time calculation means 230 ends the processing indicated in FIG. 7.

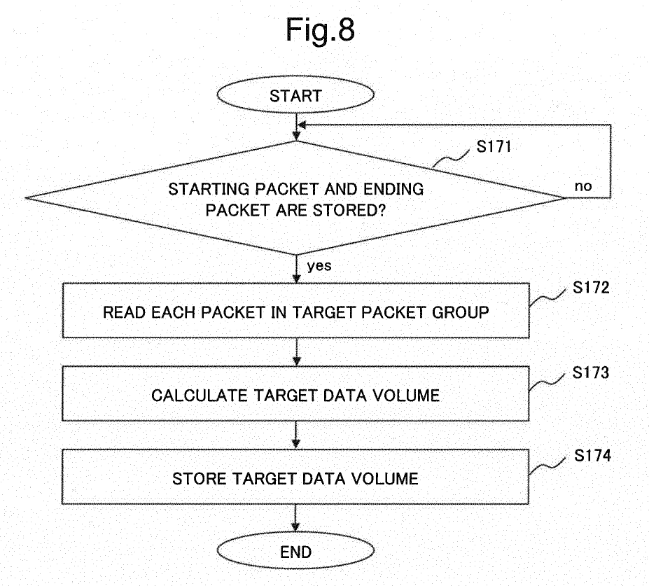

FIG. 8 is a conceptual diagram illustrating an example of a processing flow of processing performed in the target data volume calculation means 240 illustrated in FIG. 1.

First, as processing in S171, the target data volume calculation means 240 determines whether the storage means 260 stores identification information of a starting packet and identification information of an ending packet.

When determining through the processing in S171 that the storage means 260 stores the identification information of the starting packet and the identification information of the ending packet, the target data volume calculation means 240 performs processing in S172.

On the other hand, when not determining through the processing in S171 that the storage means 260 stores the identification information of the starting packet and the identification information of the ending packet, the target data volume calculation means 240 performs the aforementioned processing in S171 again.

When performing the processing in S172, the target data volume calculation means 240 reads from the storage means 260 every packet constituting a packet train and having a transmission sequence number i greater than or equal to the transmission sequence number of the starting packet and less than or equal to the transmission sequence number of the ending packet, as the processing in S172.

Then, as processing in S173, the target data volume calculation means 240 calculates a target data volume described in the description of FIG. 1. In order to calculate the target data volume, the target data volume calculation means 240 acquires from every packet read in the processing in S172 a data volume of each packet. Then, the target data volume calculation means 240 totals the acquired data volume for every packet read in the processing in S172. Then, the target data volume calculation means 240 sets as a target data volume a value obtained by totaling the acquired data volumes for all the packets read in the processing in S172.

Next, the target data volume calculation means 240 causes the storage means 260 to store the target data volume obtained through the processing in S173.

Then, the target data volume calculation means 240 ends the processing indicated in FIG. 8.

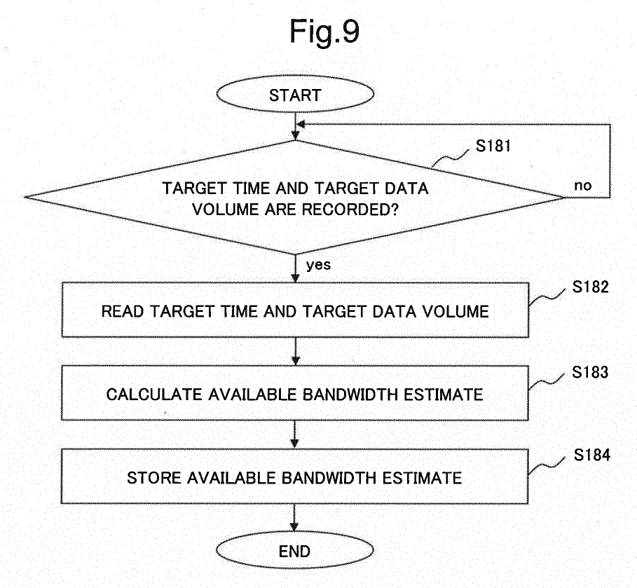

FIG. 9 is a conceptual diagram illustrating an example of a processing flow of processing performed by the estimate calculation means 250 illustrated in FIG. 1.

First, as processing in S181, the estimate calculation means 250 determines whether the storage means 260 records a target time and a target data volume.

When determining through the processing in S181 that the target time and the target data volume are recorded, the estimate calculation means 250 performs processing in S182.

On the other hand, when not determining through the processing in S181 that the target time and the target data volume are recorded, the estimate calculation means 250 performs the aforementioned processing in S181 again.

When performing the processing in S182, the estimate calculation means 250 reads from the storage means 260 the target time and the target data volume, as the processing in S182.

Then, as processing in S183, the estimate calculation means 250 calculates an available bandwidth estimate. Specifically, the estimate calculation means 250 sets as an estimate of an available bandwidth a value obtained by dividing the target data volume read through the processing in S182 by the target time read through the processing in S182.

The receiver 200 specifies a target packet group, based on a calculated delay time obtained for each delayed packet and a delay time obtained by measurement for each delayed packet. The calculated delay time is a delay time obtained by taking only influence of a target delay into consideration. Further, the delay time obtained by measurement is a delay time including influence of a delay other than the target delay and noise. Accordingly, the receiver 200 may specify a target packet in such a way to be able to reduce influence of significantly fluctuating delay times, compared with a case of not considering at least either one of the calculated delay time and the delay time obtained by measurement. The reason is that significantly fluctuating delay times are often caused by a delay other than the target delay. Then, by use of the target packet group, the receiver 200 calculates a target time and a target data volume, and calculates an available bandwidth estimate.

The receiver 200 may specify a target packet group in such a way to reduce influence of significantly fluctuating delay times, and therefore is able to reduce variation in estimates of an available bandwidth, the variation occurring in a network with significant delay time fluctuations.

### Advantageous Effects

The receiver according to the first example embodiment specifies a target packet group, based on a calculated delay time obtained for each delayed packet and a delay time obtained by measurement for each delayed packet. The calculated delay time is a delay time obtained by taking only influence of a target delay into consideration. Further, the delay time obtained by measurement is a delay time including influence of a delay other than the target delay and noise. Accordingly, the receiver according to the first example embodiment may specify a target packet in such a way to be able to reduce influence of significantly fluctuating delay times, compared with a case of not considering at least either one of the calculated delay time and the delay time obtained by measurement. The reason is that significantly fluctuating delay times are often caused by a delay other than the target delay. Then, by use of the target packet group, the receiver calculates a target time and a target data volume, and calculates an available bandwidth estimate.

The receiver according to the first example embodiment may specify a target packet group in such a way to reduce influence of significantly fluctuating delay times, and therefore is able to reduce variation in estimates of an available bandwidth, the variation occurring in a network with significant delay time fluctuations.

### Second Example Embodiment of Present Invention

A second example embodiment of the present invention (hereinafter referred to as a “second example embodiment”) is an example embodiment related to a receiver and the like estimating an available bandwidth with a packet group estimated to be delayed, by use of a delay time obtained by calculation.

[Configuration and Operation]

A configuration of a network used in an available bandwidth estimation method according to the second example embodiment and a description thereof are identical to the network configuration 900 illustrated in FIG. 1 and the description thereof, and therefore are omitted.

[Processing Flow]

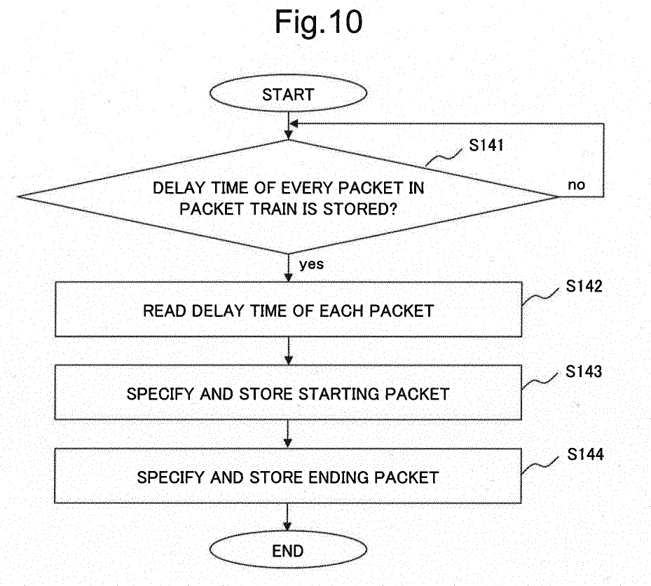

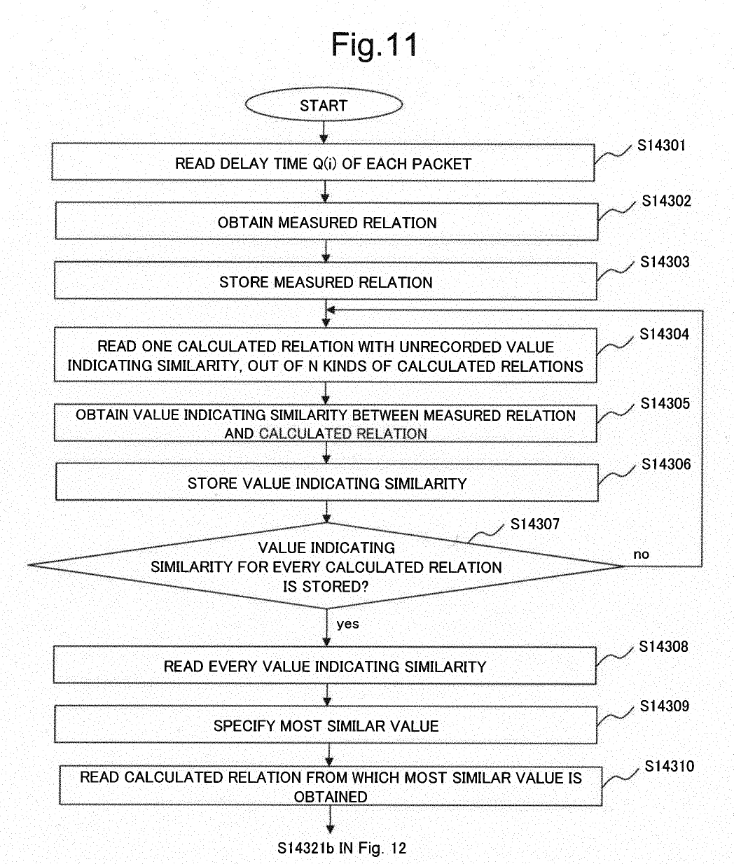

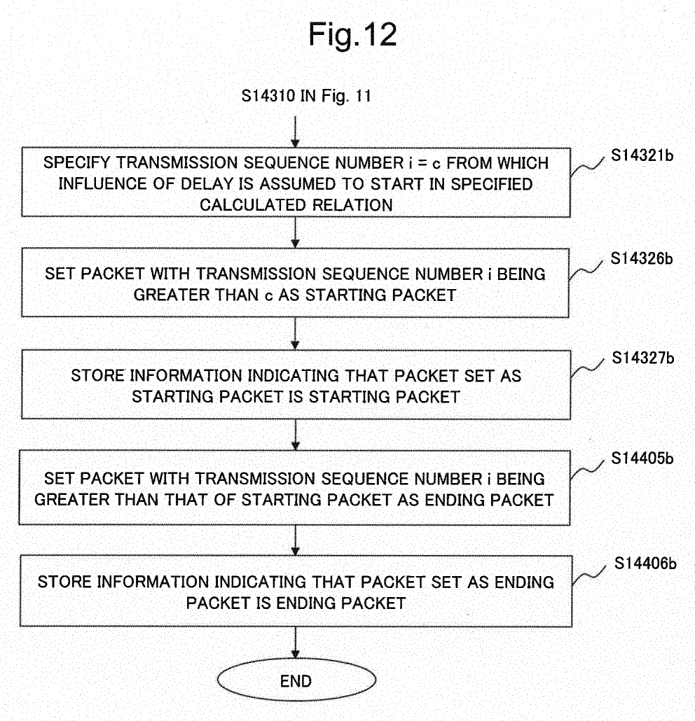

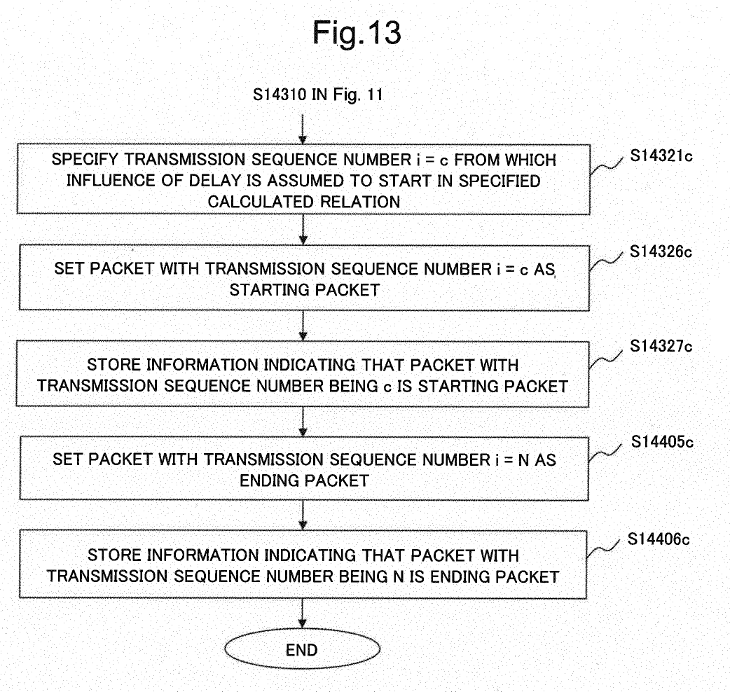

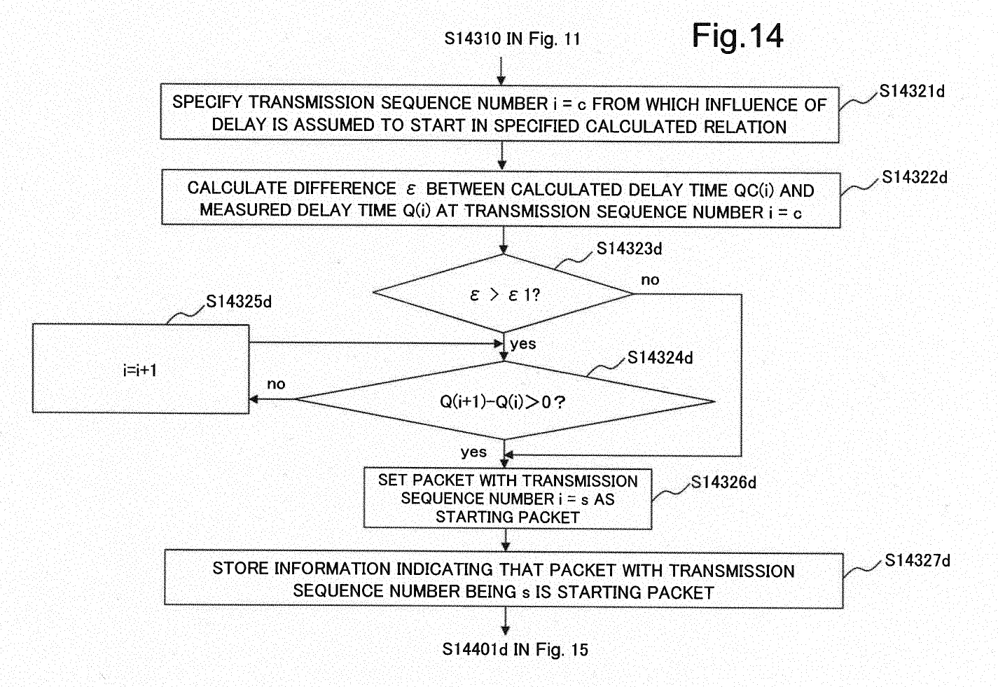

Details of processing to which the available bandwidth estimation method according to the second example embodiment is applied are obtained by replacing the processing indicated in FIG. 6 with FIG. 10 and adding processing indicated in FIGS. 11 and 12, with respect to the processing indicated in FIGS. 3 to 9. The descriptions of FIGS. 3 to 5 and FIGS. 7 to 9 remain the same as described above and therefore are omitted. FIGS. 10 to 12 will be described below.

FIG. 10 is a conceptual diagram illustrating an example of a processing flow of processing according to the second example embodiment performed by a target specification means 220 illustrated in FIG. 1.

A description of processing in S141 and S142 indicated in FIG. 10 is identical to the description of the processing in S141 and S142 indicated in FIG. 6, and therefore is omitted.

Subsequently to the processing in S142, as processing in S143, the target specification means 220 specifies a starting packet. The starting packet is a packet with the least transmission sequence number i (transmitted earliest) used in calculation of a target time by a target time calculation means 230 and calculation of a target data volume by a target data volume calculation means. A specification method of the starting packet will be described later. Then, the target specification means 220 causes a storage means 260 to store the specified starting packet.

Next, as processing in S144, the target specification means 220 specifies an ending packet. The ending packet is a packet with greatest transmission sequence number i (transmitted latest) used in calculation of a target time by the target time calculation means 230 and calculation of a target data volume by the target data volume calculation means. A specification method of the ending packet will be described later. Then, the target specification means 220 causes the storage means 260 to store the specified ending packet.

FIGS. 11 and 12 are conceptual diagrams (parts 1 and 2) illustrating an example of a processing flow of the processing in S143 and S144 indicated in FIG. 10 performed by the target specification means 220.

The processing indicated in FIGS. 11 and 12 assumes that a relation between a transmission sequence number i and a delay time QC(i) obtained by calculation (hereinafter referred to as a “calculated relation”) assuming occurrence of a delay is obtained prior to the processing. An example of a curve illustrating a calculated relation will be presented later. Further, when a target delay is a queuing delay, for example, a method of calculating an “ideal polygonal line” disclosed in PTL 2 is applicable to a method of obtaining a calculated relation. The “queuing delay” refers to a delay caused by a packet being temporarily queued on a device on a network, such as a router or a switch, when a transmission rate of the packet passing through the network exceeds an available bandwidth of the network. A calculated relation is obtained for every one of N kinds of minimum transmission sequence numbers i at which a delay occurs, where i is 1 to N. The storage means 260 stores the obtained N kinds of calculated relations prior to the processing indicated in FIGS. 11 and 12.

Then, the processing indicated in FIGS. 11 and 12 assuming the above will be described below.

First, in processing in S14301, the target specification means 220 reads from the storage means 260 a delay time Q(i) of each packet constituting a packet train being a target of the processing indicated in FIGS. 11 and 12.

Next, in processing in S14302, the target specification means 220 obtains a relation between a transmission sequence number i of each packet and the measured delay time Q(i) read through the processing in S14302 (hereinafter referred to as a “measured relation”).

Then, in S14303, the target specification means 220 causes the storage means 260 to store the measured relation obtained through the processing in S14302.

Next, in S14304, the target specification means 220 reads one of the N kinds of calculated relations stored by the storage means 260. However, the calculated relation to be read is limited to a calculated relation with respect to which a value indicating similarity, to be described later, is not stored by the storage means 260.

Then, as processing in S14305, the target specification means 220 calculates a value indicating similarity between the calculated relation read through S14304 and the measured relation obtained through the processing in S14302. For example, a mean square difference between the calculated relation and the measured relation may be used as the value indicating similarity.

Next, as processing in S14306, the target specification means 220 causes the storage means 260 to store the value indicating similarity obtained through the processing in S14305, the value being related to the calculated relation used in the processing in S14305.

Then, as processing in S14307, the target specification means 220 determines whether a value indicating similarity is stored in the storage means 260 for every one of the N kinds of calculated relations.

When determining through the processing in S14307 that a value indicating similarity is stored in the storage means 260 for every one of the N kinds of calculated relations, the target specification means 220 performs processing in S14308.

On the other hand, when not determining through the processing in S14307 that a value indicating similarity is stored in the storage means 260 for every one of the N kinds of calculated relations, the target specification means 220 performs the aforementioned processing in S14304 again.

When performing the processing in S14308, the target specification means 220 reads from the storage means 260 all the N kinds of values indicating similarity, as the processing in S14308.

Then, as processing in S14309, the target specification means 220 specifies a value indicating the highest similarity (hereinafter referred to as the “most similar value”), out of all the N kinds of values indicating similarity.

Then, as processing in S14310, the target specification means 220 reads from the storage means 260 a calculated relation from which the most similar value is obtained.

Then, as processing in S14321b, the target specification means 220 specifies a transmission sequence number i=c from which influence of a delay is assumed to start in the calculated relation read through the processing in S14310.

Then, as processing in S14326b, the target specification means 220 specifies a packet with a transmission sequence number i being greater than c as a starting packet.

Furthermore, the target specification means 220 causes the storage means 260 to store information indicating that the packet set as a starting packet through the processing in S14327b is the starting packet.

Next, as processing in S14405b, the target specification means 220 sets as an ending packet a packet with a transmission sequence number i being greater (transmitted later) than the transmission sequence number i of the packet set as the starting packet through the processing in S14405b.

Then, the target specification means 220 causes the storage means 260 to store information indicating that the packet set as an ending packet through the processing in S14406b is the ending packet.

Then, the target specification means 220 ends the processing indicated in FIGS. 11 and 12.

When performing the processing in FIGS. 10 to 12, the target specification means 220 specifies a calculated relation determined to be closest to a measured relation (S14310 in FIG. 11). Then, the target specification means 220 specifies a target packet group by specifying a starting packet and an ending packet by use of the specified calculated relation (S14326b and S14405b in FIG. 12). The calculated relation is a packet for which influence of noise and a delay due to another cause such as HARQ is not assumed. Accordingly, the processing in FIGS. 10 to 12 is able to reduce a probability of the target specification means 220 mistakenly specifying packets being delayed due to influence of noise and a delay due to another cause such as HARQ as a starting packet and an ending packet.

### Advantageous Effects

The receiver according to the second example embodiment first provides an effect similar to that provided by the receiver according to the first example embodiment. The receiver according to the second example embodiment further provides an effect as described below.

The receiver according to the second example embodiment specifies a calculated relation determined to be closest to a measured relation. Then, the receiver identifies a target packet group by specifying a starting packet and an ending packet by use of the specified calculated relation. The calculated relation is a packet for which influence of a delay due to another cause is not assumed. Accordingly, the receiver according to the second example embodiment is able to reduce a probability of mistakenly specifying packets being delayed due to influence of a delay due to another cause as a starting packet and an ending packet.

### Third Example Embodiment of Present Invention

A third example embodiment of the present invention (hereinafter referred to as a “third example embodiment”) is an example embodiment related to a receiver and the like estimating an available bandwidth with a packet group a starting point of which is set as a packet from which a delay time obtained by calculation starts to increase.

[Configuration and Operation]

A configuration of a network used in an available bandwidth estimation method according to the third example embodiment and a description thereof are identical to the network configuration 900 illustrated in FIG. 1 and the description thereof, and therefore are omitted.

[Processing Flow]

Processing to which the available bandwidth estimation method according to the third example embodiment is applied is processing obtained by replacing the processing indicated in FIG. 12 with processing indicated in FIG. 13, in the processing according to the second example embodiment. A description of processing other than the processing indicated in FIG. 13 is identical to the description of each step of the processing described in the second example embodiment and therefore is omitted.

FIG. 13 will be described below.

FIG. 13 is a conceptual diagram illustrating an example of a processing flow of processing performed by an estimate calculation means 250 illustrated in FIG. 1.

Subsequently to the processing in S14310 indicated in FIG. 11, as processing in S14321c, a target specification means 220 specifies a transmission sequence number i=c from which influence of a target delay is assumed to start in the calculated relation specified through the processing in S14310. Specifically, the transmission sequence number i=c is a transmission sequence number with the least value (transmitted earliest), out of transmission sequence numbers of packets being delayed in the calculated relation.

Then, as processing in S14326c, the target specification means 220 sets as a starting packet a packet with a transmission sequence number i=c.

As processing in S14327c, the target specification means 220 causes a storage means 260 to store information indicating that the packet with the transmission sequence number c is the starting packet.

Then, as processing in S14405c, the target specification means 220 sets as an ending packet a packet with a transmission sequence number i=N. Note that N is a total number of packets constituting a packet train.

Then, as processing in S14406c, the target specification means 220 causes the storage means 260 to store information indicating that the packet with the transmission sequence number N is the ending packet.

Then, the target specification means 220 ends the processing indicated in FIGS. 11 and 13.

As described above, when performing the processing indicated in FIG. 13, the target specification means 220 sets as a starting packet a packet with a transmission sequence number i=c from which influence of a delay is assumed to start in the calculated relation specified through the processing in S14321c and S14326c. Further, in S14405c, the target specification means 220 sets as an ending packet a packet with a transmission sequence number i=N (N being the total number of packets). Accordingly, when performing the processing in FIG. 13, it is easy to cause the target specification means 220 to automatically specify a starting packet and an ending packet.

### Advantageous Effects

The receiver according to the third example embodiment first provides an effect similar to that provided by the receiver according to the second example embodiment. The receiver according to the third example embodiment further provides an effect as described below.

The receiver according to the third example embodiment sets as a starting packet a packet with a transmission sequence number from which influence of a delay is assumed to start in a specified calculated relation. Further, the receiver sets as an ending packet a packet with the last transmission sequence number. Accordingly, it is easy for the receiver according to the third example embodiment to cause the receiver according to the third example embodiment to automatically specify a starting packet and an ending packet.

### Fourth Example Embodiment of Present Invention

A fourth example embodiment of the present invention (hereinafter referred to as a “fourth example embodiment”) is an example embodiment related to an available bandwidth estimation method of obtaining an available bandwidth estimate with a packet in a packet train less influenced by a delay due to a delay cause other than a target delay.

[Configuration and Operation]

A configuration of a network used in an available bandwidth estimation method according to the fourth example embodiment and a description thereof are identical to the network configuration 900 illustrated in FIG. 1 and the description thereof, and therefore are omitted.

[Processing Flow]

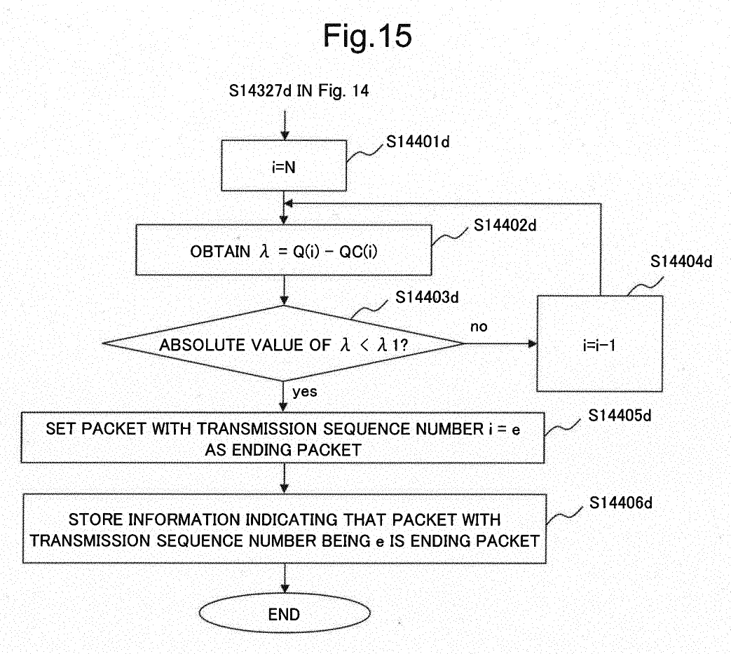

Processing performed by a receiver according to the fourth example embodiment is processing obtained by replacing the processing indicated in FIG. 13 with processing indicated in FIGS. 14 and 15, in the processing performed by the receiver according to the third example embodiment. A description of processing other than the processing indicated in FIGS. 14 and 15 is identical to the description of each step of the processing described in the third example embodiment and therefore is omitted.

FIGS. 14 and 15 will be described below.

FIGS. 14 and 15 are conceptual diagrams (parts 2-1 and 2-2) illustrating an example of a processing flow of processing performed by an estimate calculation means 250 illustrated in FIG. 1.

Subsequently to the processing in S14310 indicated in FIG. 11, as processing in S14321d, a target specification means 220 specifies a transmission sequence number i=c from which influence of delay is assumed to start in the calculated relation specified through the processing in S14310. The transmission sequence number i=c is a minimum transmission sequence number out of transmission sequence numbers i of packets in a packet group with calculated delays.

Then, as processing in S14322d, the target specification means 220 calculates a difference ε=Q(i)−QC(i) between a calculated delay time QC(i) at a packet with the transmission sequence number i=c and a measured delay time Q(i) at a packet with the transmission sequence number c.

Then, as processing in S14323d, the target specification means 220 determines whether the difference ε obtained through the processing in S14322d is greater than a preset threshold value ε1.

When determining that the difference ε obtained through the processing in S14322d is greater than the preset threshold value ε1, the target specification means 220 performs processing in S14324d.

On the other hand, when not determining that the difference ε obtained through the processing in S14322d is greater than the preset threshold value ε1, the target specification means 220 performs processing in S14326d.

When performing the processing in S14324d, the target specification means 220 determines whether Q(i+1)−Q(i) is positive, as the processing in S14324d. The delay time Q(i+1) denotes a delay time of a packet with a transmission sequence number i=i+1, and the delay time Q(i) denotes a delay time of a packet with a transmission sequence number i=i.

When determining through the processing in S14324d that Q(i+1)−Q(i) is positive, the target specification means 220 performs processing in S14326d.

On the other hand, when not determining through the processing in S14324d that Q(i+1)−Q(i) is positive, the target specification means 220 performs processing in S14325d.

When performing the processing in S14325d, the target specification means 220 substitutes i+1 for the transmission sequence number i, as the processing in S14325d.

Then, the target specification means 220 performs the aforementioned processing in S14324d.

When performing the processing in S14326d, the target specification means 220 sets as a starting packet a packet with a transmission sequence number i=s, as the processing in S14326d. The transmission sequence number s denotes a value substituted for i when the processing in S14326d is performed.

As processing in S14327d, the target specification means 220 causes a storage means 260 to store information indicating that the packet with the transmission sequence number s is the starting packet.

Next, the target specification means 220 performs processing in S14401d indicated in FIG. 15.

When performing the processing in S14401d indicated in FIG. 15, the target specification means 220 substitutes a total number of packets N constituting a packet train for the transmission sequence number i, as the processing in S14401d.

Then, as processing in S14402d, the target specification means 220 obtains a difference λ=Q(i)−QC(i) between a delay time QC(i) and a delay time Q(i). The delay time QC(i) denotes a calculated delay time at a transmission sequence number i=N in the calculated relation read in S14310. Further, the delay time Q(N) denotes a measured delay time at a transmission sequence number i=N in a measured relation.

Then, as processing in S14403d, the target specification means 220 determines whether the difference λ obtained through the processing in S14402d is less than a predetermined threshold value λ1.

When determining through the processing in S14403d that the difference λ is less than the threshold value λ1, the target specification means 220 performs processing in S14405d.

On the other hand, when not determining through the processing in S14403d that the difference λ is less than the threshold value λ1, the target specification means 220 performs processing in S14404d.

When performing the processing in S14404d, the target specification means 220 substitutes i−1 for the transmission sequence number i, as the processing in S14404d.

Then, the target specification means 220 performs the aforementioned processing in S14402d again.

When performing the processing in S14405d, the target specification means 220 sets as an ending packet a packet with a transmission sequence number i=e, as the processing in S14405d. Note that e denotes a value substituted for the transmission sequence number i when performing the processing in S14405d.

Then, as processing in S14406d, the target specification means 220 causes the storage means 260 to store information indicating that the packet with the transmission sequence number e is the ending packet.

Then, the target specification means 220 ends the processing indicated in FIGS. 7, 14, and 15.

### Specific Example

A specific example of the processing performed by the receiver according to the fourth example embodiment will be described below.

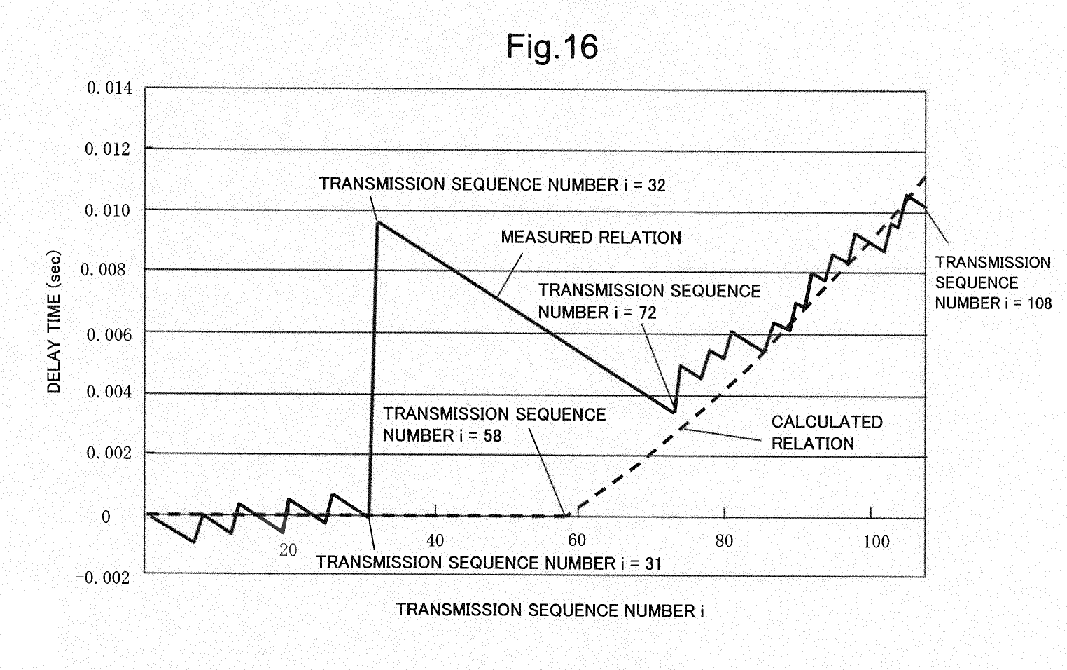

FIG. 16 is a conceptual diagram illustrating a first specific example of the processing performed by the receiver according to the fourth example embodiment. FIG. 16 illustrates a relation between a transmission sequence number i and a queuing delay time of a packet with the transmission sequence number i. A solid line in FIG. 16 and a dotted line in FIG. 16 indicate a measured relation and a calculated relation, respectively. The calculated relation illustrated in FIG. 16 is a calculated relation obtained by the calculation method of an “ideal polygonal line” disclosed in PTL 2, assuming that a target delay is a queuing delay.

Further, the calculated relation in FIG. 16 is a calculated relation by which a most similar value is obtained with respect to a measurement result indicated by the solid line, the relation being read from the storage means 260 by the target specification means 220 through the processing in S14310 indicated in FIG. 11.

In the following description of FIG. 16, a processing number starting with “S” indicates a processing number of processing indicated in FIG. 14 or 15, and a reference sign indicates a reference sign in the configuration illustrated in FIG. 1.

According to the measured relation illustrated in FIG. 16, a delay time Q(i) sharply increases between a transmission sequence number i=31 and a transmission sequence number i=32 from 0 to 0.0095 sec. It is assumed that HARQ in a network 300 occurred at a thirty-second packet.

Subsequently, the delay time linearly decreases between the transmission sequence number i=32 and a transmission sequence number i=72. The linear decrease in delay time is assumed to be due to influence of generation of arrival acceleration processing in the network 300, such as simultaneous arrival of packets or the like.

On the other hand, according to the calculated relation, a delay time is zero up to a transmission sequence number i=57, whereas the delay time increases at and beyond a transmission sequence number i=58.

Next, the specification method of a starting packet using the calculated relation and the measured relation that are illustrated in FIG. 16 will be described.

First, a transmission sequence number i=58 from which influence of a delay is assumed to start in the calculated relation is specified through the processing in S14321d.

Then, as the processing in S14322d, the target specification means 220 calculates a difference ε=Q(i)−QC(i)=0.006 sec. The delay time Q(i)=0.006 sec is a measured delay time at a packet with the transmission sequence number i=58. Further, the delay time QC(i)=0 is a calculated delay time at the packet with the transmission sequence number i=58.

Next, as the processing in S14323d indicated in FIG. 14, the target specification means 220 illustrated in FIG. 1 determines whether the difference ε is greater than a preset threshold value ε1=0.004 sec. The threshold value ε1=0.004 sec is half of 0.008 sec being a retransmission time of HARQ and is a previously assumed value.

Since the difference ε=0.006 sec is greater than the threshold value ε1=0.004 sec, the target specification means 220 determines through the processing in S14323d that the difference ε is greater than the preset threshold value ε1. Then, as the processing in S14324d, the target specification means 220 determines whether Q(59)−Q(58) is positive. The delay time Q(59) denotes a delay time of a packet with a transmission sequence number i=59, and the delay time Q(58) denotes a delay time of the packet with the transmission sequence number i=58.

Since Q(59)−Q(58) is negative according to FIG. 16, the target specification means 220 substitutes 58+1=59 for the transmission sequence number i, as the processing in S14325d.

Then, the target specification means 220 determines whether Q(60)−Q(59) is positive.

Since Q(60)−Q(59) is negative according to FIG. 16, the target specification means 220 substitutes 59+1=60 for the transmission sequence number i, as the processing in S14325d.

Then, the target specification means 220 repeats performing the processing in S14325d and the processing in S14324d following the processing in S14325d, until substituting 72 for the transmission sequence number i as the processing in S14324d.

Then, as the processing in S14325d, the target specification means 220 substitutes 72 for the transmission sequence number i.

Next, as the processing in S14324d, the target specification means 220 determines whether Q(73)−Q(72) is positive.

The target specification means 220 determines through the processing in S14324d that Q(73)−Q(72) is positive according to FIG. 16, and as the processing in S14326d, sets as a starting packet a packet with the transmission sequence number i=72.

Next, the specification method of an ending packet using the calculated relation and the measured relation that are illustrated in FIG. 16 will be described.

According to FIG. 16, a total number of packets N constituting a packet train being a target is N=108.

Then, as the processing in S14401d, the target specification means 220 substitutes the total number of packets N=108 for the transmission sequence number i.

Then, as the processing in S14402d, the target specification means 220 obtains a difference λ=Q(108)−QC(108) between a delay time QC(108) and a delay time Q(108). The delay time QC(108) denotes a calculated delay time at the transmission sequence number i=108 in the calculated relation. Further, the delay time Q(N) denotes a measured delay time at the transmission sequence number i=108 in the measured relation.

Then, as the processing in S14403d, the target specification means 220 determines whether the difference λ obtained through the processing in S14401d is less than a predetermined threshold value λ1.

According to FIG. 16, the delay time QC(108) is 0.011 sec, and the delay time Q(108) is 0.010 sec. Accordingly, the difference λ becomes λ =Q(108)−QC(108)=−0.001 sec. It is assumed that a threshold value λ1=0.004 sec is preset.

Then, λ=−0.0001 sec is a value less than the threshold value λ1=0.004 sec.

Accordingly, through the processing in S14403d, the difference −0.0001 sec is determined to be less than the threshold value λ1=0.004 sec.

Accordingly, through the processing in S14405d, a packet at the transmission sequence number i=108 is set as an ending packet.

Then, a target time calculation means 230 illustrated in FIG. 1 calculates a target time through the processing indicated in FIG. 7, based on respective reception times of the starting packet being a packet with a transmission sequence number i being 72 and the ending packet being a packet with a transmission sequence number i being 108.

Further, a target data volume calculation means 240 calculates a target data volume through the processing indicated in FIG. 8, by use of received data volumes of respective packets from the transmission sequence number i=72 of the starting packet to the transmission sequence number i=108 of the ending packet.

Then, the estimate calculation means 250 illustrated in FIG. 1 calculates an available bandwidth estimate through the processing indicated in FIG. 9.

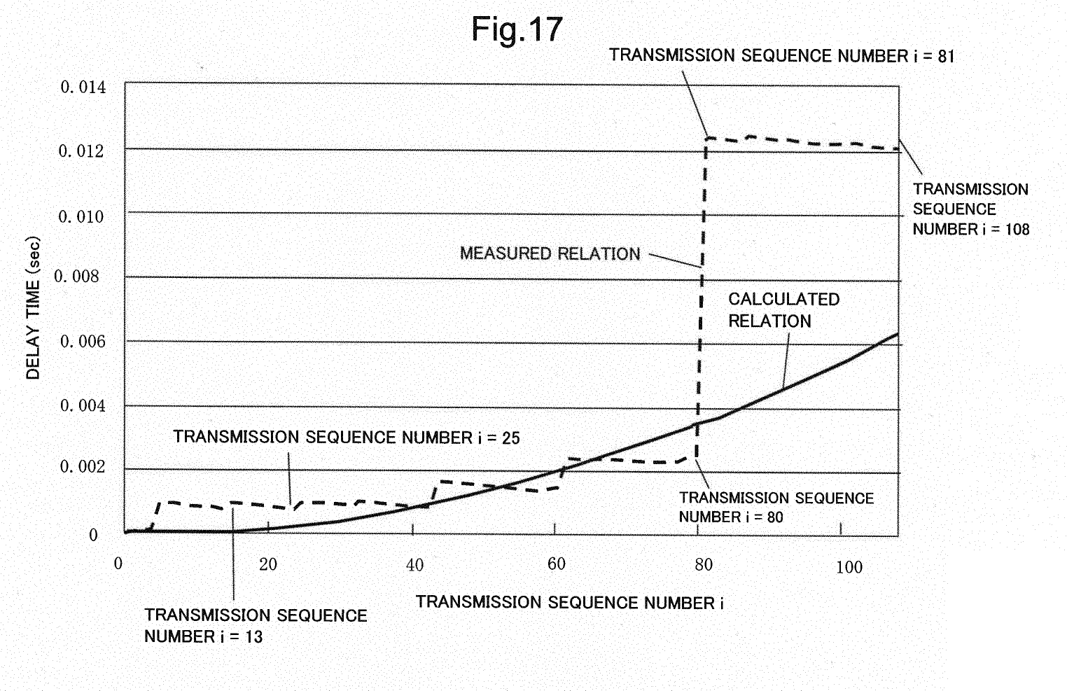

FIG. 17 is a conceptual diagram illustrating a second specific example of the processing performed by the receiver according to the fourth example embodiment. FIG. 17 illustrates a relation between a transmission sequence number i and a queuing delay time of a packet at the transmission sequence number i. A solid line in FIG. 17 and a dotted line in FIG. 17 indicate a measured relation and a calculated relation, respectively.

The calculated relation illustrated in FIG. 17 is a calculated relation obtained by the calculation method of an “ideal polygonal line” disclosed in PTL 2, assuming that a delay is a queuing delay.

Further, the calculated relation in FIG. 17 illustrates a calculated relation by which a most similar value is obtained with respect to the measurement result indicated by the solid line, the relation being read from the storage means 260 by the target specification means 220 through the processing in S14310 indicated in FIG. 11.

In the following description of FIG. 17, a processing number starting with “S” indicates a processing number of processing indicated in FIG. 14 or 15, and a reference sign indicates a reference sign in the configuration illustrated in FIG. 1.

According to the measured relation illustrated in FIG. 17, a delay time Q(i) sharply increases between a transmission sequence number i=80 and a transmission sequence number i=81 from 0.0025 sec to 0.0127 sec. It is assumed that a delay due to HARQ occurred at the eighty-first packet.

Subsequently, the delay time linearly decreases between the transmission sequence number i=81 and a transmission sequence number i=108.

On the other hand, according to the calculated relation, a delay time is zero up to a transmission sequence number i=13, whereas the delay time increases at and beyond a transmission sequence number i=14.

Next, the specification method of a starting packet using the calculated relation and the measured relation that are illustrated in FIG. 17 will be described.

First, a transmission sequence number i=13 from which influence of a delay is assumed to start in the calculated relation is specified through the processing in S14321d.

Then, as the processing in S14322d, the target specification means 220 calculates a difference ε=Q(i)−QC(i)=0.0009 sec. The delay time Q(i)=0.001 sec is a measured delay time at a packet with the transmission sequence number i=13. Further, the delay time QC(i)=0.0001 is a calculated delay time at a packet with the transmission sequence number i=13.

Next, as the processing in S14323d illustrated in FIG. 14, the target specification means 220 illustrated in FIG. 1 determines whether the difference ε is greater than a preset threshold value ε1=0.0004 sec.

Since the difference ε=0.0009 sec is greater than the threshold value ε1=0.0004 sec, the target specification means 220 determines that the difference ε is greater than the preset threshold value ci through the processing in S14323d. Then, as the processing in S14324d, the target specification means 220 determines whether Q(14)−Q(13) is positive. The delay time Q(14) denotes a delay time of a packet with a transmission sequence number i=14, and the delay time Q(13) denotes the delay time of a packet with the transmission sequence number i=13.

Since Q(14)−Q(13) is negative according to FIG. 17, the target specification means 220 substitutes 13+1=14 for the transmission sequence number i, as the processing in S14325d.

Then, the target specification means 220 determines whether Q(15)−Q(14) is positive.

Since Q(15)−Q(14) is negative according to FIG. 17, the target specification means 220 substitutes 14+1=15 for the transmission sequence number i, as the processing in S14325d.

Then, the target specification means 220 repeats performing the processing in S14325d and the processing in S14324d following the processing in S14325d, until substituting 25 for the transmission sequence number i as the processing in S14324d.

Then, as the processing in S14325d, the target specification means 220 substitutes 25 for the transmission sequence number i.

Next, as the processing in S14324d, the target specification means 220 determines whether Q(26)−Q(25) is positive.

The target specification means 220 determines through the processing in S14324d that Q(26)−Q(25) is positive according to FIG. 17, and as the processing in S14326d, sets as a starting packet a packet with the transmission sequence number i=25.

Next, the specification method of an ending packet using the calculated relation and the measured relation that are illustrated in FIG. 17 will be described.

According to FIG. 17, a total number of packets N constituting a packet train being a target is N=108.

Accordingly, as the processing in S14401d, the target specification means 220 substitutes the total number of packets N=108 for the transmission sequence number i.

Then, as the processing in S14402d, the target specification means 220 obtains a difference λ=Q(108)−QC(108) between a delay time QC(108) and a delay time Q(108). The delay time QC(108) denotes a calculated delay time at the transmission sequence number i=108 in the calculated relation. Further, the delay time Q(N) denotes a measured delay time at the transmission sequence number i=108 in the measured relation.

Then, as the processing in S14403d, the target specification means 220 determines whether the difference λ obtained through the processing in S14402d is less than a predetermined threshold value λ1.

According to FIG. 17, the delay time QC(108) is 0.0063 sec, and the delay time Q(108) is 0.0121 sec. Accordingly, the difference λ becomes λ=Q(108)−QC(108)=0.0058 sec. It is assumed that a threshold value λ1=0.004 sec is preset.

Then, λ=0.0058 sec is a value greater than the threshold value λ1=0.004 sec.

Accordingly, through the processing in S14403d, the target specification means 220 does not determine that λ=0.0058 sec is less than the threshold value λ1=0.004 sec.

Accordingly, as the processing in S14404d, the target specification means 220 substitutes i−1 for the transmission sequence number i. In other words, the transmission sequence number i becomes i=107.

Then, through the processing in S14402d, the target specification means 220 obtains a difference λ=Q(107)−QC(107)=0.0059 sec.

Then, through the processing in S14403d, the target specification means 220 does not determine that λ=0.0059 sec is less than the threshold value λ1=0.004 sec.

Accordingly, as the processing in S14404d, the target specification means 220 substitutes i−1 for the transmission sequence number i. In other words, the transmission sequence number i becomes i=106.

Subsequently, the target specification means 220 repeats the processing in S14402d to S14404d, and the target specification means 220 substitutes i=80 for the transmission sequence number i.

Then, through the processing in S14402d, the target specification means 220 obtains a difference λ=Q(80)−QC(80)=−0.0016 sec.

Then, through the processing in S14403d, the target specification means 220 determines that the difference λ=−0.016 sec is less than the threshold value λ1=0.004 sec.

Accordingly, through the processing in S14405d, the target specification means 220 sets as an ending packet a packet with the transmission sequence number i=80.

Then, the target time calculation means 230 illustrated in FIG. 1 calculates a target time through the processing indicated in FIG. 7, based on respective reception times of the starting packet being a packet with a transmission sequence number i being 13 and the ending packet being a packet with a transmission sequence number i being 80.

Further, the target data volume calculation means 240 calculates a target data volume through the processing indicated in FIG. 8, by use of received data volumes of respective packets from the transmission sequence number i=13 of the starting packet to the transmission sequence number i=80 of the ending packet.

Then, the estimate calculation means 250 illustrated in FIG. 1 calculates an available bandwidth estimate through the processing indicated in FIG. 9.

The receiver 200 selects a starting packet by performing the processing in S14321d to S14326d by use of the specified calculated relation. Out of the processing in S14321d to S14326d, the processing in and after S14322d is processing for excluding a packet influenced by a delay due to another cause such as HARQ from a target packet group (packets with transmission sequence numbers i greater than the transmission sequence number i of the starting packet). Further, the receiver 200 specifies an ending packet through the processing in S14401d to S14405d in FIG. 15. Out of the processing in S14401d to S14405d, the processing in and after S14402d is processing for excluding a packet influenced by a delay due to another cause such as HARQ from the target packet group (packets with transmission sequence numbers i less than the transmission sequence number i of the ending packet).

Accordingly, a probability of a packet constituting the target packet group being less influenced by a delay due to another cause such as HARQ is high.

The receiver 200 obtains an available bandwidth estimate, based on a target time and a target data volume that are obtained by use of information of the target packet group. Accordingly, the receiver described in the specific example is able to reduce influence of a delay due to another cause.

[Measurement Example]

Next, a measurement example of available bandwidth estimation by the receiver according to the fourth example embodiment will be introduced.

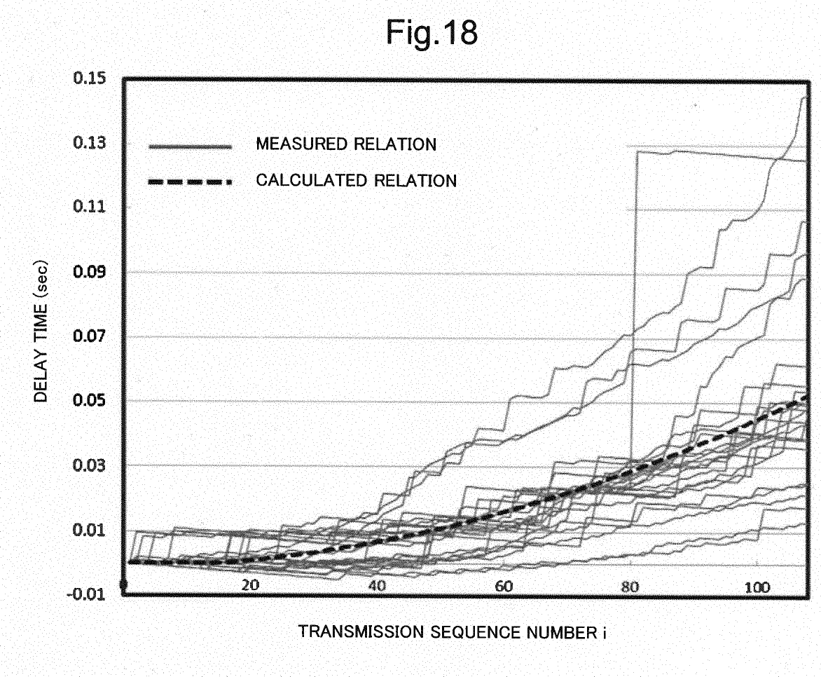

FIG. 18 is a diagram illustrating a relation between a delay and a transmission sequence number i of a packet constituting a packet train, in a reception means 210 illustrated in FIG. 1. In FIG. 18, a dotted line indicates a calculated relation, and a solid line indicates a measured relation. The respective plurality of measured relations illustrated in FIG. 18 are related to mutually different times at which a transmitter 100 started transmitting to the receiver 200 packet trains with an identical configuration used in the respective measured relations.

FIG. 18 illustrates that various measured relations are obtained depending on a time at which the transmitter 100 starts transmitting the packet train to the receiver 200 in the network configuration 900.

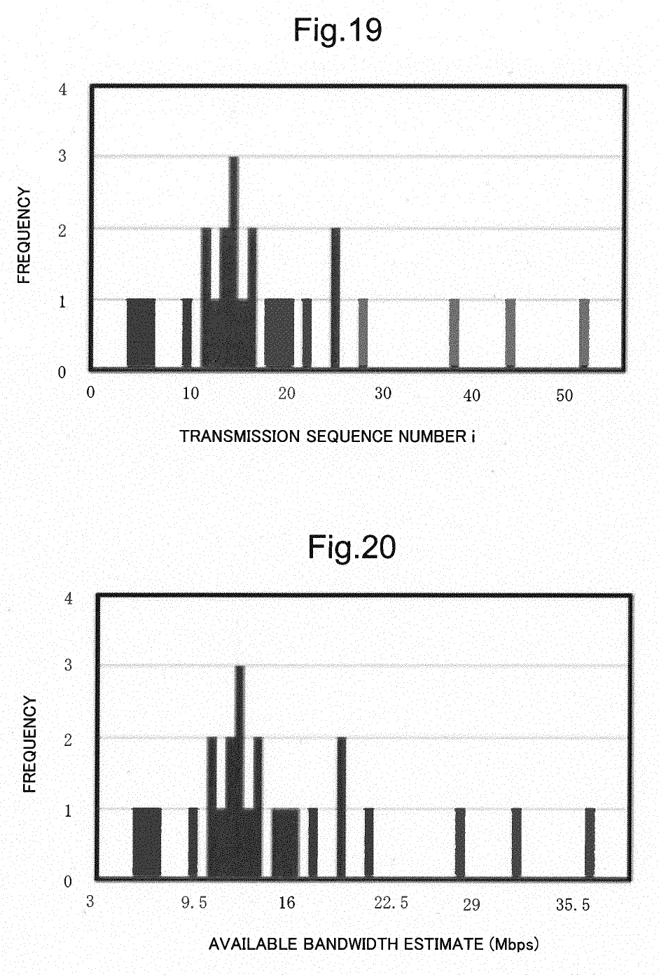

FIG. 19 is a diagram illustrating a frequency of a delay starting to increase at a packet with a transmission sequence number i in the measured relations illustrated in FIG. 18.

A frequency of a delay starting to increase varies by transmission sequence number i.

FIG. 20 is a diagram illustrating a frequency of a calculated available bandwidth estimate when the estimate is obtained by the method disclosed in PTL 2 by use of the measured relation and the calculated relation that are illustrated in FIG. 18, without applying the invention according to the present example embodiment.

The available bandwidth estimates obtained by the method disclosed in PTL 2 without applying the invention according to the present example embodiment vary in various values.

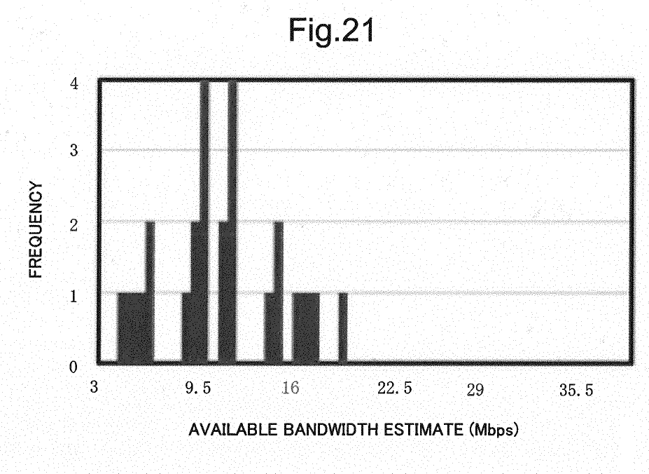

FIG. 21 is a diagram illustrating a frequency of a calculated available bandwidth estimate when the estimate is obtained by the receiver according to the present example embodiment by use of the measured relation and the calculated relation that are illustrated in FIG. 18.

The available bandwidth estimates illustrated in FIG. 21 obtained by the receiver according to the fourth example embodiment exhibit a smaller amount of variation compared with the available bandwidth estimates illustrated in FIG. 20 obtained by the method disclosed in PTL 2 without applying the invention according to the present example embodiment.

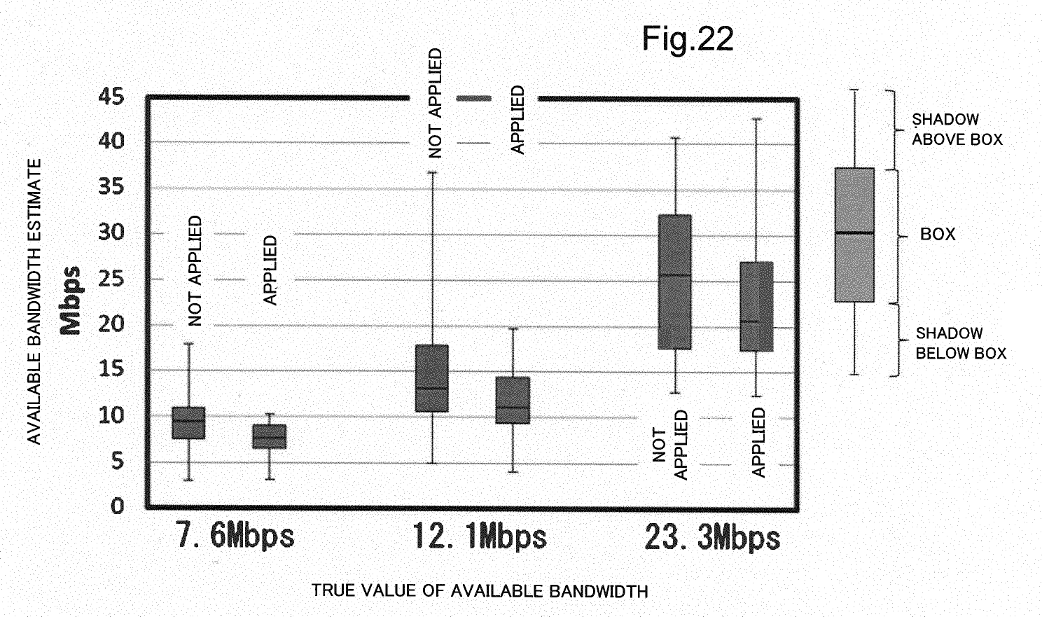

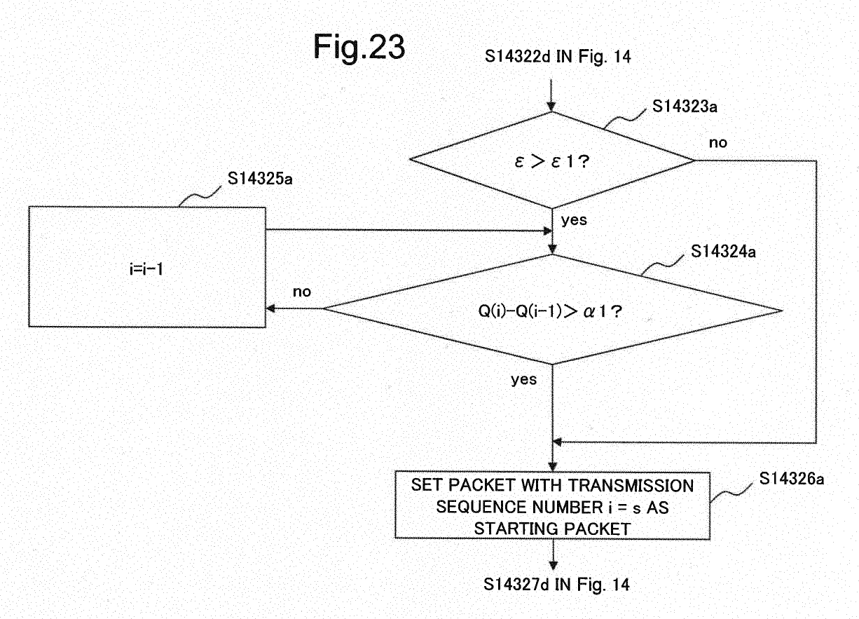

FIG. 22 is a diagram illustrating a frequency of a calculated available bandwidth estimate in each case of a true value of an available bandwidth of the network 300 being 7.6 Mbps, 12.1 Mbps, and 23.3 Mbps. FIG. 22 illustrates a frequency of a calculated available bandwidth estimate when 25 train packets are transmitted from the transmitter to the receiver in each case of 7.6 Mbps, 12.1 Mbps, and 23.3 Mbps. A box part in FIG. 22 represents available bandwidth estimates with respect to 25 train packets within a range of 25% to 75% from the top when the available bandwidth estimates are sorted in ascending order. Further, a shadow part below the box represents available bandwidth estimates within a range of 0% to 25% from the top. A shadow part above the box represents available bandwidth estimates within a range of 75% to 100% from the top. The “box,” the “shadow below the box,” and the “shadow above the box” are described in the margin in FIG. 22. Data labeled as “NOT APPLIED” in FIG. 16 represent a calculated frequency of available bandwidth estimates obtained by the method disclosed in PTL 2, without applying the invention according to the present example embodiment. Further, data labeled as “APPLIED” represent a calculated frequency of available bandwidth estimates obtained by applying the available bandwidth estimation method according to the fourth example embodiment.

According to FIG. 22, an amount of variation in available bandwidth estimates obtained by the receiver according to the fourth example embodiment is kept smaller compared with an amount of variation in available bandwidth estimates obtained without applying the invention according to the present example embodiment. The amount of variation in available bandwidth estimates obtained by the receiver according to the fourth example embodiment is kept lower in every case of a true value of an available bandwidth being 7.6 Mbps, 12.1 Mbps, and 23.3 Mbps.

### Advantageous Effects

The receiver according to the fourth example embodiment first provides an effect similar to that provided by the receiver according to the third example embodiment. The receiver according to the fourth example embodiment further provides an effect as described below.

The receiver according to the fourth example embodiment selects a starting packet and an ending packet through processing to which processing for excluding a packet influenced by a delay due to another cause from a target packet group is applied, by use of a specified calculated relation. Accordingly, a probability of a packet constituting a target packet group specified by the starting packet and the ending packet being less influenced by a delay due to another cause is high.

The receiver according to the fourth example embodiment obtains an available bandwidth estimate, based on a target time and a target data volume obtained by use of information of a target packet group. Accordingly, the receiver described in the specific example is able to reduce influence of delay due to another cause.

### Fifth Example Embodiment of Present Invention

A fifth example embodiment of the present invention (hereinafter referred to as a “fifth example embodiment”) is an example embodiment related to a receiver obtaining an available bandwidth estimate with a packet group being a packet train including a packet influenced by a delay due to a delay cause other than a target delay cause.

[Configuration and Operation]

A configuration of a network applied to a receiver according to the fifth example embodiment and a description thereof are identical to the network configuration 900 illustrated in FIG. 1 and the description thereof, and therefore are omitted.

[Processing Flow]

Processing performed by the receiver according to the fifth example embodiment is processing obtained by replacing the processing in S14323d to S14326d indicated in FIG. 14 with processing in S14323a to S14326a indicated in FIG. 23, in the processing performed by the receiver according to the fourth example embodiment. A description of processing performed by the receiver according to the fifth example embodiment other than S14323a to S14326a indicated in FIG. 14 is identical to the description of the processing performed by the receiver according to the aforementioned fourth example embodiment except for the processing in S14323d to S14326d, and therefore is omitted.

FIG. 23 is a conceptual diagram illustrating an example of a processing flow of processing in S143 indicated in FIG. 10 performed by a target specification means 220. FIG. 23 only indicates processing replacing the processing in S14323d to S14326d indicated in FIG. 14.

Subsequently to the processing in S14322d indicated in FIG. 14, as processing in S14323a, the target specification means 220 illustrated in FIG. 1 determines whether a difference ε obtained through the processing in S14322d is greater than a preset threshold value ε1.

When determining through the processing in S14323a that the difference ε obtained through the processing in S14322d is greater than the preset threshold value ε1, the target specification means 220 performs processing in S14324a.

On the other hand, when not determining through the processing in S14323a that the difference ε obtained through the processing in S14322d is greater than the preset threshold value ε1, the target specification means 220 performs processing in S14326a.

When performing the processing in S14324a, the target specification means 220 determines whether Q(i)−Q(i−1) is greater than al, as the processing in S14324a. The delay time Q(i−1) denotes a delay time of a packet with a transmission sequence number i=i−1, and the delay time Q(i) denotes a delay time of a packet with a transmission sequence number i=i.

When determining through the processing in S14324a that Q(i)−Q(i−1) is greater than al, the target specification means 220 performs processing in S14326a.

On the other hand, when not determining through the processing in S14324a that Q(i)−Q(i−1) is greater than al, the target specification means 220 performs processing in S14325a.

When performing the processing in S14325a, the target specification means 220 substitutes i−1 for the transmission sequence number i, as the processing in S14325a.

Then, the target specification means 220 performs the aforementioned processing in S14324a.

When performing the processing in S14326a, the target specification means 220 sets as a starting packet a packet with a transmission sequence number i=s, as the processing in S14326a. The transmission sequence number s denotes a value substituted for i when the processing in S14326a is performed.

Then, the target specification means 220 performs processing in S14327d indicated in FIG. 14.

### Specific Example

A specific example of the processing performed by the receiver according to the fifth example embodiment will be described below.

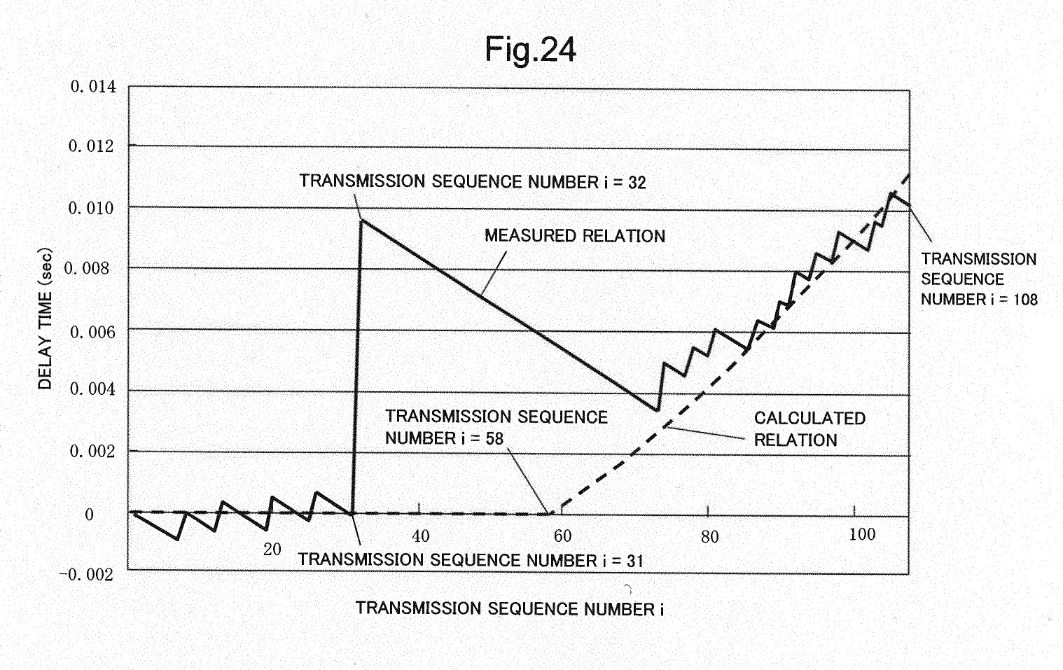

FIG. 24 is a conceptual diagram illustrating a specific example of the processing performed by the receiver according to the fifth example embodiment. FIG. 24 illustrates a relation between a transmission sequence number i and a queuing delay time of a packet with the transmission sequence number i. A solid line in FIG. 24 and a dotted line in FIG. 24 indicate a measured relation and a calculated relation, respectively.

A description of the measured relation and the calculated relation illustrated in FIG. 24 is identical to the description of the measured relation and the calculated relation illustrated in FIG. 16 and therefore is omitted.

Next, the specification method of a starting packet according to the fifth example embodiment using the calculated relation and the measured relation that are illustrated in FIG. 24 will be described.

In the following description of FIG. 24, a processing number starting with “S” and not including a symbol “a” indicates a processing number of processing indicated in FIG. 14, a processing number starting with “S” and including a symbol “a” indicates a processing number of processing indicated in FIG. 23, and a reference sign indicates a reference sign in the configuration illustrated in FIG. 1.

First, through processing in S14321d, a transmission sequence number i=58 from which influence of a delay is assumed to start in the calculated relation is specified.

Then, as processing in S14322d, the target specification means 220 calculates a difference c=Q(i)−QC(i)=0.0058 sec at the transmission sequence number i=58. The delay time Q(58)=0.0058 sec is a measured delay time at a packet with the transmission sequence number i=58. Further, the delay time QC(i)=0 is a calculated delay time at a packet with a transmission sequence number c.

Next, as the processing in S14323d indicated in FIG. 14, the target specification means 220 illustrated in FIG. 1 determines whether the difference c is greater than a preset threshold value ε1=0.004 sec. The threshold value ε1=0.004 sec is half of 0.008 sec being a retransmission time of HARQ and is a previously assumed value.

Since the difference c=0.0058 sec is greater than the threshold value ε1=0.004 sec, the target specification means 220 determines through the processing in S14323a that the difference c is greater than the preset threshold value ε1. Then, as the processing in S14324a, the target specification means 220 determines whether Q(58)−Q(57) is greater than a threshold value al. The delay time Q(58) denotes a delay time of the packet with the transmission sequence number i=58, and the delay time Q(57) denotes a delay time of a packet with a transmission sequence number i=57.

As for the threshold value al, it is assumed that the threshold value α1=0.008 sec is preset.

Since Q(58)−Q(57) is less than the threshold value α1=0.008 sec according to FIG. 24, the target specification means 220 substitutes 58−1=57 for the transmission sequence number i, as the processing in S14325a.

Then, the target specification means 220 determines whether Q(57)−Q(56) is greater than the threshold value α1=0.008 sec.

Since Q(57)−Q(56) is less than the threshold value α1=0.008 sec according to FIG. 24, the target specification means 220 substitutes 57−1=56 for the transmission sequence number i, as the processing in S14325a.

Then, the target specification means 220 repeats performing the processing in S14325a and the processing in S14324a following the processing in S14325a, until substituting 32 for the transmission sequence number i as the processing in S14324a.

Then, as the processing in S14325a, the target specification means 220 substitutes 32 for the transmission sequence number i.

Next, as the processing in S14324a, the target specification means 220 determines whether Q(32)−Q(31) is greater than the threshold value α1=0.008 sec.

The target specification means 220 determines through the processing in S14324a that Q(32)−Q(31) is greater than the threshold value α1=0.008 sec according to FIG. 24, and as the processing in S14326a, sets as a starting packet a packet with a transmission sequence number i=32.

A description of a specification method of an ending packet using the calculated relation and the measured relation that are illustrated in FIG. 24 is identical to the description of the specification method of an ending packet using the calculated relation and the measured relation that are illustrated in FIG. 16, and therefore is omitted.

Further, a description of a calculation method of a target time, a target data volume, and an available bandwidth estimate using the relations illustrated in FIG. 24 is identical to the description of the calculation method of a target time, a target data volume, and an available bandwidth estimate using the relations illustrated in FIG. 16, and therefore is omitted.

The receiver described in the specific example specifies a target packet group with transmission sequence numbers i between a transmission sequence number of a starting packet and a transmission sequence number of an ending packet, based on packets constituting a packet train received by a receiver 200 illustrated in FIG. 1. The starting packet is a packet with a transmission sequence number immediately preceding a transmission sequence number of a packet from which influence of a delay due to HARQ emerges. Further, the ending packet is a packet at which influence of the delay due to HARQ does not exist. Additionally, the ending packet is a packet at which influence of a queuing delay being a target delay in available bandwidth estimation exists.

Selection of the ending packet at which influence of a queuing delay exists is performed through the processing in and after S14401d indicated in FIG. 15 using a calculated relation determined to be most similar to the measured relation.

Processing of selecting as the starting packet a packet with a transmission sequence number immediately preceding a transmission sequence number of a packet from which influence of a delay due to HARQ emerges is performed through the processing in S14323a to S14325a indicated in FIG. 23. Further, selection of the ending packet less influenced by a delay due to HARQ is performed through the processing in S14402d to S14404d indicated in FIG. 15.

The target packet group being packets with transmission sequence numbers between a transmission sequence number of the starting packet and a transmission sequence number of the ending packet is a packet group including a packet group influenced by a delay due to HARQ. However, the influence of the delay due to HARQ does not exist at the starting packet and the ending packet. The influence of the delay due to HARQ not existing at the ending packet means that almost all packets being delayed by the influence of HARQ are highly likely to have arrived at an arrival time of the ending packet. Accordingly, an error occurring in calculation of a target data volume by a target data volume calculation means 240 through the processing indicated in FIG. 23, by use of the target packet group, is small.

On the other hand, an error may occur in identification of a reception time of the starting packet. Accordingly, a target time calculated by a target time calculation means 230 through the processing indicated in FIG. 9 may have an error.

However, as described above, at least an error in the target data volume is small. Accordingly, an available bandwidth estimate calculated by the receiver described in the specific example is able to reduce the influence of the delay due to HARQ, compared with a case of the target time and the target data volume both have significant errors.

### Advantageous Effects

The receiver according to the fifth example embodiment first provides an effect similar to that provided by the receiver according to the fourth example embodiment. The receiver according to the fourth example embodiment further provides an effect as described below.

The receiver according to the fifth example embodiment selects a starting packet and an ending packet through processing to which processing for excluding a packet influenced by a delay due to another cause from a target packet group is applied, by use of a specified calculated relation. Accordingly, a probability of a packet constituting the target packet group specified by the starting packet and the ending packet being less influenced by the delay due to another cause is high.

The receiver according to the fifth example embodiment obtains an available bandwidth estimate, based on a target time and a target data volume that are obtained by use of information of the target packet group. Accordingly, the receiver described in the specific example is able to reduce influence of the delay due to another cause.

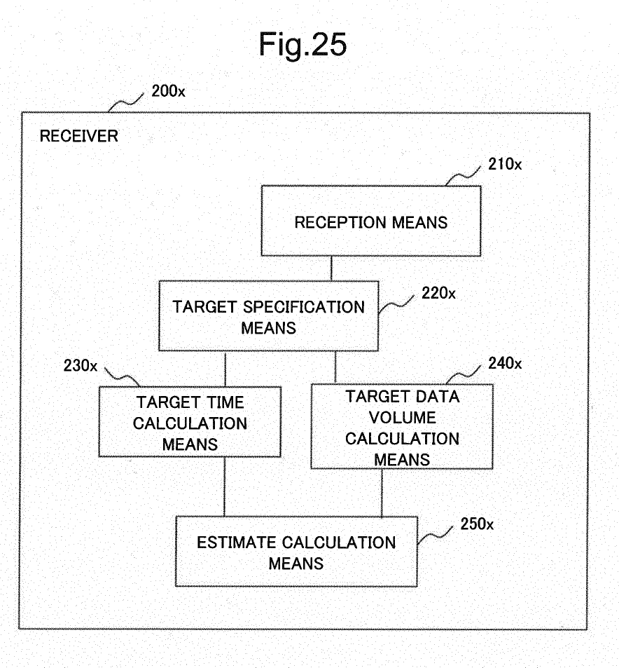

FIG. 25 is a conceptual diagram illustrating a receiver 200x being a minimum configuration of a receiver according to the present invention.

The receiver 200x includes a reception means 210x, a target specification means 220x, a target time calculation means 230x, a target data volume calculation means 240x, and an estimate calculation means 250x.

The reception means 210x receives a packet transmitted to the reception means 210x through an unillustrated network.

The target specification means 220x specifies a target packet group composed of target packets from a delayed packet group composed of delayed packets. The delayed packet is the packet being delayed when passing through the network. Further, the target packet is the packet used for calculation of the available bandwidth estimate. A target packet is specified based on a calculated delay time obtained for each of the delayed packets and a delay time obtained by measurement for each of the delayed packets. A target delay is a delay assumed for calculation of an available bandwidth estimate.

The target time calculation means 230x calculates a target time being an estimate of a time required for the target packet group to pass through the network.

The target data volume calculation means 240x calculates a target data volume being a total estimate of received data volumes of respective target packets constituting the target packet group.

The estimate calculation means 250x obtains the available bandwidth estimate by dividing the target data volume by the target time.

With the aforementioned configuration, the receiver 200x provides an effect described in Advantageous Effects of Invention.

Further, the aforementioned example embodiments may also be described in part or in whole as the following Supplementary Notes but are not limited thereto.

(Supplementary Note A1)

A receiver including:

a reception means for receiving one or more packets transmitted through a network;

a target specification means for specifying, from a delayed packet group composed of one or more delayed packets being the packets being delayed when passing through the network, a target packet group composed of one or more target packets being the packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets;

a target time calculation means for calculating a target time being an estimate of a time required for the target packet group to pass through the network;

a target data volume calculation means for calculating a target data volume being a total estimate of received data volumes of respective target packets constituting the target packet group; and

an estimate calculation means for obtaining the available bandwidth estimate by dividing the target data volume by the target time.

(Supplementary Note A2)

The receiver according to Supplementary Note A1, wherein

the target packet group is composed of the packets successively received by the reception means.

(Supplementary Note A3)

The receiver according to Supplementary Note A1 or A2, wherein

target packets constituting the target packet group are the packets transmitted by an identical transmitter.

(Supplementary Note A4)

The receiver according to Supplementary Note A3, wherein

the packet constituting the target packet group is the packet characterized by a target packet transmitted later by the transmitter having a larger capacity.

(Supplementary Note A5)

The receiver according to Supplementary Note A3 or A4, wherein

the packets constituting the target packet group are the packets transmitted at regular intervals by the transmitter.

(Supplementary Note A6)

The receiver according to any one of Supplementary Notes A3 to A5, wherein

the packet constituting the target packet group is the packet selected from a group of the packets constituting a packet train transmitted by the transmitter.

(Supplementary Note A7)

The receiver according to any one of Supplementary Notes A1 to A6, wherein

the target delay is a queuing delay.

(Supplementary Note A8)

The receiver according to any one of Supplementary Notes A1 to 7, wherein

influence reduction processing for reducing influence of a delay other than the target delay is performed.

(Supplementary Note A9)

The receiver according to Supplementary Note A8, wherein

the influence reduction processing is performed by the target specification means.

(Supplementary Note A10)

The receiver according to Supplementary Note A8 or A9, wherein

a delay other than the target delay is a delay influenced by Hybrid

Automatic Repeat reQuest.

(Supplementary Note A11)

The receiver according to any one of Supplementary Notes A1 to A10, wherein

the delayed packet group including the packet the calculated delay time of which is positive is specified as the target packet group.

(Supplementary Note A12)

The receiver according to any one of Supplementary Notes A1 to A11, wherein

the delayed packet group composed of the delayed packet with a transmission sequence number from a transmitter to the reception means being greater than or equal to a transmission sequence number of the delayed packet with the minimum transmission sequence number is specified as the target packet group, the calculated delay time of the delayed packet being positive.

(Supplementary Note A13)

The receiver according to any one of Supplementary Notes A1 to A12, wherein

the delayed packet group selected from the delayed packet group composed of the delayed packet with a transmission sequence number from a transmitter to the reception means being greater than or equal to a transmission sequence number of the delayed packet with the minimum transmission sequence number is specified as the target packet group, the calculated delay time of the delayed packet being positive.

(Supplementary Note A14)

The receiver according to any one of Supplementary Notes A1 to A13, wherein

the delayed packet group composed of the delayed packet with the transmission sequence number being less than or equal to the transmission sequence number of the delayed packet with the maximum transmission sequence number is specified as the target packet group, the calculated delay time of the delayed packet being positive.

(Supplementary Note A15)

The receiver according to any one of Supplementary Notes A17 to A14, wherein

at each target packet constituting the target packet, a value obtained by subtracting the calculated delay time from a measured delay time is less than a predetermined threshold value, the measured delay time being a delay time obtained by measurement.

(Supplementary Note A15)

The receiver according to any one of Supplementary Notes A1 to A14, wherein

at the target packet with the minimum transmission sequence number, a value obtained by subtracting the calculated delay time from a measured delay time is less than a predetermined threshold value, the measured delay time being a delay time obtained by measurement.

(Supplementary Note A16)

The receiver according to any one of Supplementary Notes A1 to A15, wherein

at the target packet with the maximum transmission sequence number, a value obtained by subtracting the calculated delay time from a measured delay time is less than a predetermined threshold value, the measured delay time being a delay time obtained by measurement.

(Supplementary Note A17)

The receiver according to any one of Supplementary Notes A1 to A16, wherein

at the target packet with the minimum transmission sequence number, the calculated delay time is zero.

(Supplementary Note A18)

The receiver according to any one of Supplementary Notes A1 to A17, wherein

a measured delay time obtained by measurement at the packet with the transmission sequence number immediately preceding the transmission sequence number of the target packet with the minimum transmission sequence number is less than a predetermined threshold value.

(Supplementary Note A19)

The receiver according to Supplementary Note A17 or A18, wherein

a measured delay time, being a delay time obtained by measurement, at the packet with the transmission sequence number immediately succeeding the transmission sequence number of the target packet with the minimum transmission sequence number is less than a measured delay time of the target packet with the minimum transmission sequence number.

(Supplementary Note A20)

The receiver according to any one of Supplementary Notes A17 to A19, wherein

a delayed packet group including nearly all the delayed packets influenced by a delay other than the target delay is specified as a target packet group.

(Supplementary Note A21)

The receiver according to Supplementary Note A20, wherein

a delay other than the target delay is a delay due to influence of Hybrid Automatic Repeat reQuest.

(Supplementary Note A22)

The receiver according to any one of Supplementary Notes A1 to A21, wherein

the calculated delay is a delay obtained by use of a relation between the calculated delay and a transmission sequence number, the relation being determined by the target specification means to be similar to a relation between a measured delay time and a transmission sequence number with respect to the target packet group.

(Supplementary Note B1)

A transmitter that transmits one or more packets to a receiver that:

receives the packets transmitted through a network;

specifies, from a delayed packet group composed of one or more delayed packets being the packets being delayed when passing through the network, a target packet group composed of one or more target packets being the packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets;

calculates a target time being an estimate of a time required for the target packet group to pass through the network;

calculates a target data volume being a total estimate of received data volumes of respective target packets constituting the target packet group; and

obtains the available bandwidth estimate by dividing the target data volume by the target time.

(Supplementary Note C1)

A transmission-reception system including:

a receiver that
receives one or more packets transmitted through a network,
specifies, from a delayed packet group composed of one or more delayed packets being the packets being delayed when passing through the network, a target packet group composed of one or more target packets being the packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets,
calculates a target time being an estimate of a time required for the target packet group to pass through the network,
calculates a target data volume being a total estimate of received data volumes of respective target packets constituting the target packet group, and
obtains the available bandwidth estimate by dividing the target data volume by the target time; and

a transmission means for transmitting the packets.

(Supplementary Note DO

A method for estimating an available bandwidth, the method including:

receiving one or more packets transmitted through a network;

specifying, from a delayed packet group composed of one or more delayed packets being the packets being delayed when passing through the network, a target packet group composed of one or more target packets being packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets;

calculating a target time being an estimate of a time required for the target packet group to pass through the network;

calculating a target data volume being a total estimate of received data volumes of respective target packets constituting the target packet group; and

obtaining the available bandwidth estimate by dividing the target data volume by the target time.

(Supplementary Note E1)

An available bandwidth estimate calculation program causing a computer to execute processing including:

processing of receiving one or more packets transmitted through a network;

processing of specifying, from a delayed packet group composed of one or more delayed packets being the packets being delayed when passing through the network, a target packet group composed of one or more target packets being packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets;

processing of calculating a target time being an estimate of a time required for the target packet group to pass through the network;

processing of calculating a target data volume being a total estimate of received data volumes of respective target packets constituting the target packet group; and

processing of obtaining the available bandwidth estimate by dividing the target data volume by the target time.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent applications No. 2015-252961 filed on Dec. 25, 2015, the disclosure of which is incorporated herein in its entirety by reference.

### REFERENCE SIGNS LIST

20 Packet identification information
21 Packet size
22a Transmission interval
22b Total number of packets
23 Starting packet identification information
24 Ending packet identification information
25 Target time
26 Target data volume
27 Available bandwidth estimate
100 Transmitter
110 Transmission means
120 Generation means
200, 200x Receiver
210, 210x Reception means
220, 220x Target specification means
230, 230x Target time calculation means
240, 240x Target data volume calculation means
250, 250x Estimate calculation means
260 Storage means
300 Network
800 Data structure
900 Network configuration

What is claimed is:

1. A receiver including:
a receiving circuit for receiving one or more packets transmitted through a network;
a target specification circuit for specifying, from a delayed packet group composed of one or more delayed packets being the packets being delayed when passing through the network, a target packet group composed of one or more target packets being the packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets;
a target time calculation circuit for calculating a target time being an estimate of a time required for the target packet group to pass through the network;
a target data volume calculation circuit for calculating a target data volume being a total estimate of received data volumes of respective target packets constituting the target packet group; and
an estimate calculation circuit for calculating the available bandwidth estimate by dividing the target data volume by the target time.

2. The receiver according to claim 1, wherein
the delayed packet group including the packet the calculated delay time of which is positive is specified as the target packet group.

3. The receiver according to claim 1, wherein
the delayed packet group composed of the delayed packet with a transmission sequence number from a transmitter to the receiving circuit being greater than or equal to a transmission sequence number of the delayed packet with the earliest sequence number is specified as the target packet group, the calculated delay time of the delayed packet being positive.

4. The receiver according to claim 1, wherein
the delayed packet group selected from the delayed packet group composed of the delayed packet with a transmission sequence number from a transmitter to the receiving circuit being greater than or equal to a transmission sequence number of the delayed packet with the minimum transmission sequence number is specified as the target packet group, the calculated delay time of the delayed packet being positive.

5. The receiver according to claim 1, wherein
the delayed packet group composed of the delayed packet with the transmission sequence number being less than or equal to the transmission sequence number of the delayed packet with the latest transmission sequence number is specified as the target packet group, the calculated delay time of the delayed packet being positive.

6. The receiver according to claim 1, wherein
at the target packet with the minimum transmission sequence number, a value obtained by subtracting the calculated delay time from a measured delay time is less than a predetermined threshold value, the measured delay time being a delay time obtained by measurement.

7. The receiver according to claim 1, wherein
at the target packet with the maximum transmission sequence number, a value obtained by subtracting the calculated delay time from a measured delay time is less than a predetermined threshold value, the measured delay time being a delay time obtained by measurement.

8. The receiver according to claim 1, wherein
at the target packet with the minimum transmission sequence number, the calculated delay time is zero.

9. A transmitter that transmits one or more packets to a receiver that:
receives the packets transmitted through a network;
specifies, from a delayed packet group composed of one or more delayed packets being the packets being delayed when passing through the network, a target packet group composed of one or more target packets being the packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets;
calculates a target time being an estimate of a time required for the target packet group to pass through the network;
calculates a target data volume being a total estimate of received data volumes of respective target packets constituting the target packet group; and
obtains the available bandwidth estimate by dividing the target data volume by the target time.

10. A method for estimating an available bandwidth, the method including:
receiving one or more packets transmitted through a network;
specifying, from a delayed packet group composed of one or more delayed packets being the packets being delayed when passing through the network, a target packet group composed of one or more target packets being packets used for calculation of an available bandwidth estimate, based on a calculated delay time obtained for each of the delayed packets, assuming a target delay being a delay assumed for calculation of the available bandwidth estimate, and a delay time obtained by measurement for each of the delayed packets;
calculating a target time being an estimate of a time required for the target packet group to pass through the network;
calculating a target data volume being a total estimate of received data volumes of respective target packets constituting the target packet group; and
obtaining the available bandwidth estimate by dividing the target data volume by the target time.
